(19) United States
(12) Patent Application Publication
(10) Pub. No.: US 2007/0198604 A1
(43) Pub. Date: Aug. 23, 2007

(54) Computer system, computer system management console, and data recovery management method

(75) Inventors: Wataru Okada, Yokohama (JP); Masahide Sato, Noda (JP); Hironori Emaru, Yokohama (JP); Nobuhiro Maki, Yokohama (JP); Yuri Hiraiwa, Sagamihara (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/401,259

(22) Filed: Apr. 11, 2006

(30) Foreign Application Priority Data
Feb. 21, 2006 (JP) 2006-044416

(51) Int. Cl. G06F 17/30

(52) U.S. Cl. 707/202

(57) ABSTRACT

A computer system that is able to recover data at an arbitrary point in time using journals even after a data volume has been migrated between storage apparatuses. The computer system has a data recovery management unit create continuous journal data that ensures the continuity of journals before and after the migration of the data volume and, based on that continuous journal data, recovers the data.

### CROSS REFERENCES TO RELATED APPLICATIONS

This application relates to and claims priority from Japanese Patent Application No. 2006-044416, filed on Feb. 21, 2006, the entire disclosure of which is incorporated herein by reference.

### BACKGROUND OF THE INVENTION

The present invention relates to a computer system where a host computer is connected to a storage apparatus, with a management console for managing the storage apparatus also included; a management console for the computer system; and a recovery management method for data in the computer system.

Normally, in information systems having storage apparatuses, when data is lost due to the occurrence of a failure in the storage apparatuses, user error or data destruction by computer viruses, the lost data can be recovered because data volumes are backed up on a regular basis.

As backup and recovery techniques, data backup and recovery techniques using journaling have been proposed in, for example, US Patent Publication No. 2005/0015416. This document discloses a configuration in which a snapshot (i.e., a full backup image or a logical image including a differential backup image) of a logical group (hereinafter called ‘journal group’) containing at least one data volume is obtained at a specific point in time; data subsequently written in the data volume is maintained as a journal (called an ‘After-journal’); a series of After-journals is applied to the obtained snapshot in the order in which data was written; and thus data from the specific point in time can be recovered. This technique is an example of so-called ‘Continuous Data Protection’ or ‘CDP’ techniques.

The foregoing document also proposes a method for undoing the application of After-journals when the data recovered by applying the After-journals has already been destroyed. It also discloses that data to be overwritten during the application of After-journals is saved and, when the application of After-journals is undone, the snapshot taken before the application of After-journals can be recovered in a short period of time by applying the saved data to the post-After-journal application snapshot (i.e., writing the saved data back to the snapshot). The saved data is called a ‘Before-journal.’

A technique for obtaining an After-journal and Before-journal at the same time upon writing by a host computer is disclosed in Japanese Patent Laid-open Publication No. 2004-252686. By using this technique, past data can be recovered by applying a Before-journal to an operating volume. Incidentally, in the following explanation, After-journals, Before-journals, and metadata for managing the journals are collectively simply called ‘journals.’ Also, a snapshot to which a journal is applied upon recovery is called a ‘base snapshot.’

Japanese Patent Laid-Open Publication No. 2003-345522 proposes a technique for migrating, in a computer system including a plurality of storage apparatuses, a data volume between the storage apparatuses in order to distribute the storage apparatus loads.

Finally, Japanese Patent Laid-Open Publication No. 2005-011277 proposes an external connection technique for establishing a system where a plurality of storage apparatuses is consolidated. This document discloses that a first storage apparatus is connected to a second storage apparatus and a volume the first storage apparatus provides to a host system is provided to the host as a virtual volume in the second storage apparatus via the second storage apparatus.

### SUMMARY OF THE INVENTION

According to the foregoing publications No. 2005-0015416 and No. 2004-252686, a snapshot is created in a storage apparatus a data volume belongs to. A journal is created in a storage apparatus that has received a write request from a host; in other words, a storage apparatus a data volume belongs to. In this situation, the technique disclosed in the foregoing publication No. 2003-345522 is used to migrate a data volume between storage apparatuses, snapshots and journals are distributed between and stored in different storage apparatuses before and after the migration. When recovering a data volume in this situation, the storage apparatus executing the recovery (hereinafter called ‘recovery-executing storage apparatus’) cannot access the snapshots and journals necessary for the recovery, and the data image at an arbitrary point in time may not be recovered.

In order to solve the foregoing problem, this invention provides a computer system that is able to recover data at an arbitrary point in time by using a journal even after a data volume has been migrated between storage apparatuses.

This invention is characterized in that continuous journal data, which ensures the continuity of journals before and after migration of a data volume, is created by a data recovery management unit and, based on the continuous journal data, data backup/recovery is executed in a computer system.

Specifically, this invention is a computer system having: a data volume storing data used by a host computer; a journal volume maintaining, as a journal, information for writing in the data volume; a recovery controller using, when recovering the data volume, a data image of the data volume obtained at a time near the recovery point as a base and applying the journal to the data image to perform the recovery; a data migration controller controlling, when there is a plurality of storage apparatus each having a data volume, migration of data between data volumes in those storage apparatuses; a connection controller issuing an I/O request from one storage apparatus from among the plurality of storage apparatuses to another storage apparatus; and a management computer controlling the plurality of storage apparatuses based on management information. When migrating data between the data volumes in the storage apparatuses, the management computer creates continuous management information where there is continuity between a journal obtained in relation to the data volume in a data migration source storage apparatus and a journal obtained in relation to the data volume in a data migration destination storage apparatus.

This invention can provide a computer system able to recover data at an arbitrary point in time by using a journal even after a data volume has been migrated between storage apparatuses; a management computer used for the computer system; and a method for recovering data.

### BRIEF DESCRIPTION OF THE DRAWINGS

FIG. 1 is a diagram showing the system configuration according to a first embodiment of this invention.

FIG. 2 is a diagram showing an example of a logical volume management table according to the first embodiment of this invention.

FIG. 3 is a diagram showing an example of a path management table according to the first embodiment of this invention.

FIG. 4 is a diagram showing an example of a virtual volume management table according to the first embodiment of this invention.

FIG. 5 is a diagram showing an example of a journal group table according the first embodiment of this invention.

FIG. 6 is a diagram showing an example of a data volume table according to the first embodiment of this invention.

FIG. 7 is a diagram showing an example of a snapshot volume table according to the first embodiment of this invention.

FIG. 8 is a diagram showing an example of a snapshot group table according to the first embodiment of this invention.

FIG. 9 is a diagram showing an example of a journal volume table according to the first embodiment of this invention.

FIG. 10 is a diagram showing an example of the configuration of a journal according to the first embodiment of this invention.

FIG. 11 is a diagram showing an example of a storage table according to the first embodiment of this invention.

FIG. 12 is a diagram showing an example of a journal consolidation information table according to the first embodiment of this invention.

FIG. 13 is a diagram showing an example, according to the first embodiment of this invention, of a data volume migration processing operation based on a volume migration management program 1251.

FIG. 14 is a diagram showing an example, according to the first embodiment of this invention, of an update processing operation performed for journal consolidation information, based on the volume migration management program 1251.

FIG. 15 is a diagram showing an example, according to the first embodiment of this invention, of a data volume deletion processing operation based on the volume migration management program 1251.

FIG. 16 is a diagram showing an example, according to the first embodiment of this invention, of a recovery execution processing operation performed by a CDP management program 1252.

FIG. 17 is a diagram showing an example, according to the first embodiment of this invention, of a recovery execution processing operation performed by a storage micro program 1028.

FIG. 18A is a diagram showing an example, according to the first embodiment of this invention, of processing to identify the journal to be read next based on the storage micro program 1028 when performing recovery using an After-journal.

FIG. 18B is a diagram showing an example, according to the first embodiment of this invention, of processing to identify the journal to be read next based on the storage micro program 1028 when performing recovery using a Before-journal.

FIG. 19 is a diagram showing the system configuration according to a second embodiment of this invention.

FIG. 20 is a diagram showing an example of a logical volume management table according to the second embodiment of this invention.

FIG. 21 is a diagram showing an example, according to the second embodiment of this invention, of a data volume migration processing operation based on the volume migration management program 1251.

FIG. 22 is a diagram showing an example, according to the second embodiment of this invention, of an I/O request processing operation for an I/O request received during data copy processing, which is involved in data volume migration, based on the storage micro program 1028.

FIG. 23 is a diagram showing the system configuration according to a third embodiment of this invention.

FIG. 24 is a diagram showing an example of a logical volume management table according the third embodiment of this invention.

FIG. 25 is a diagram showing an example of a virtual volume management table according to the third embodiment of this invention.

FIG. 26 is a diagram showing an example, according to the third embodiment of this invention, of a recovery execution processing operation based on the CDP management program 1252.

### DETAILED DESCRIPTION OF THE INVENTION

Embodiments of this invention are described below in detail with reference to the attached drawings. Incidentally, this invention is not limited by these embodiments. In the explanation below, storage apparatuses other than a recovery-executing storage apparatus are called external storage apparatuses, journals stored in the external storage apparatuses are called external journals, snapshots stored in the external storage apparatuses are called external snapshots, volumes storing external journals are called external journal volumes, and volumes storing external snapshots are called external snapshot volumes.

Also, the point in time designated by an administrator when recovering data at a specific point in time is called a ‘recovery point.’ When recovering data at a designated recovery point by applying a series of journals to a snapshot, the relationship between the last-applied journal and the designated recovery point is described by saying ‘the journal has the recovery point.’ If data can be recovered without having to applying journals to a snapshot, the relationship between the snapshot and the designated recovery point is described by saying ‘the snapshot has the recovery point.’

### First Embodiment

1. System Configuration

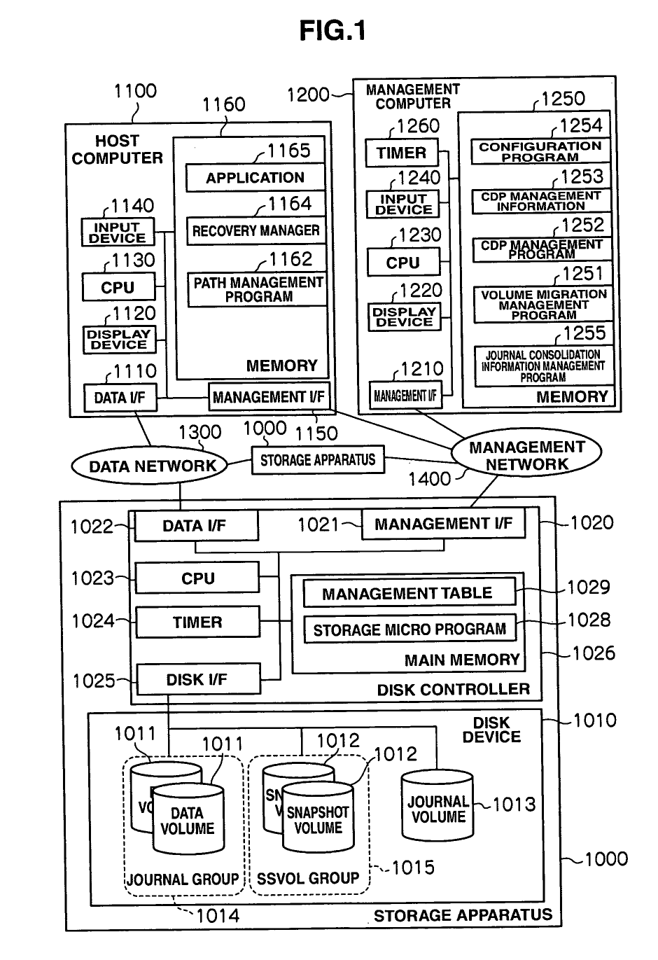

FIG. 1 is a block diagram showing the configuration of a computer system. A storage apparatus 1000 and a host computer 1100 are connected to each other via a data network 1300. The data network 1300, which is a storage area network, may be an IP network or other data communication network(s).

The storage apparatus 1000, host computer 1100 and management computer 1200 are connected to one another via a management network 1400. The management network 1400, which is an IP network, may also be a storage area network or other data communication network(s). The data network 1300 and management network 1400 may be part of the same network, and the host computer 1100 and management computer 1200 may also be part of the same computer. Although the system shown in FIG. 1 has two storage apparatuses 1000, one host computer 1100 and one management computer 1200, the number of these devices is not limited.

The storage apparatus 1000 has a disk device 1010 for storing data and a disk controller 1020 for controlling the storage apparatus. The disk device 1010 has a journal group 1014, snapshot volume (SSVOL) group 1015, and journal volume 1013.

The journal group 1014 is configured from one or more data volumes 1011. The data volume 1011 is a logical volume storing data used by the host computer 1100. One or more journal volumes 1013 and one or more SSVOL groups 1015 are associated with the journal group 1014. The journal volume is a logical volume storing journals. The SSVOL group 1015 will be described later.

A write request from the host computer 1100 to the data volume 1011 is processed by a CPU 1023, which operates according to a storage micro program 1028 described later, and write data is reflected in the data volume 1011. Here, the CPU 1023 creates journals—the data to be written is made into an After-journal and the data to be overwritten is made into a Before-journal—and provides them with appropriate management metadata by, for example, assigning sequence numbers in the order of transmission of the journals. The CPU 1023 then stores these journals in the journal volume 1013 associated with the journal group 1014 the data volume 1011 belongs to. The metadata and sequence numbers will be explained later, together with the configuration of the journals. Incidentally, when there is a storage area shortage for a new journal, the CPU 1023 deletes the oldest journal from the journal volume 1013 so that the new journal can be stored in the created space. In another embodiment, when processing a write request from the host computer 1100, the CPU 1023 may create a journal having only either an After-journal or Before-journal.

The SSVOL group 1015 is composed of one or more snapshot volumes 1012. The snapshot volume 1012 is a logical volume storing a plurality of images (snapshots) of the data volume 1011 at certain points in time. Incidentally, a snapshot stored in the snapshot volume 1012 may be a full backup image or a logical image including a differential backup of the data volume 1011, depending on the requirements for and installation of the system.

Incidentally, for ease of explanation, there is only one journal group 1014 in FIG. 1; however, there may be more than one journal group 1014.

The disk controller 1020 has a management I/F 1021, data I/F 1022, disk I/F 1025, main memory 1026, CPU 1023, and timer 1024.

The main memory 1026 stores a management table 1029 and storage micro program 1028. The CPU 1023 executes the program stored in the main memory 1026.

The storage micro program 1028 is for having the CPU 1023 execute various functions for backup and recovery using journaling, previously described in the background section, such as acquisition of snapshots, creation of journals, recovery using journals, and release of the journals. Incidentally, when performing recovery using journals, the CPU 1023, operating according to the storage micro program 1028, performs recovery by reading journals and snapshots from volumes in external storage apparatuses as necessary.

Moreover, the storage micro program 1028 also has the CPU 1023 control the functions of: copying data to another storage apparatus; performing external connection; processing the input and output of data to and from the disk device 1010 in response to requests from the management computer 1200 and host computer 1100; and setting and providing control information within the storage apparatus. The CPU 1023 controls these functions while referring to and updating the information in the management table 1029, according to the storage micro program 1028. The configuration of the management table 1029 will be described later.

The timer 1024 is a normal timer having the role of providing the current time. The CPU 1023, operating according to the storage micro program 1028, refers to this timer when creating journals and snapshots.

The data I/F 1022 is an interface for the data network 1300 and has one or more communication ports. Via this port, the disk controller 1020 transmits and receives data and control commands to and from the host computer 1100 and other storage apparatuses 1000. The management I/F 1021 is an interface for the management network 1400, and transmits and receives data and control commands to and from the host computer 1100 and management computer 1200. The disk I/F 1025 is an interface for the disk device 1010, and transmits and receives data and control commands.

The host computer 1100 is composed of input devices 1140 such as a keyboard and mouse; CPU 113; a display device 1120 such as a CRT; memory 1160; data I/F 1110; and management I/F 1150.

The data I/F 1110 is an interface for the data network 1300 and has one or more communication ports. Via these ports, the host computer 1100 transmits and receives data and control commands to and from the storage apparatus 1000. The management I/F 1150 is an interface for the management network 1400, and transmits and receives data and control commands to and from the management computer 1200 and the storage apparatus 1000 for system management. The memory 1160 stores an application 1165, recovery manager 1164, and path management program 1162.

The CPU 1130, operating according to the path management program 1162, manages paths (e.g., identifiers, such as WWNs, of ports in the data I/F 1022 in the storage apparatus, and SCSI (Small Computer System Interface)-based target IDs and logical unit numbers (LUNs)) for the host computer 1100 to access the data volume 1011, and switches paths depending on requests from the administrator and other programs. The application 1165 is an application such as a DBMS or a file system using the data volumes 1011.

The CPU 1130, operating according to the recovery manager 1164, makes a request to the storage apparatus 1000 to obtain a snapshot and recover data at a specific point in time, and it also staticizes the application 1165. In order for the administrator or other programs to execute these functions, the recovery manager 1164 provides a command line interface (hereinafter called ‘CLI’) or the like as an interface. Incidentally, for ease of explanation, there is only one application 1163 in FIG. 1; however, there may be two or more applications 1163.

The management computer 1200 is composed of input devices 1240 such as a keyboard and mouse; CPU 1230; a display device 1220 such as a CRT; memory 1250; management I/F 1210; and timer 1260. The management I/F 1210 transmits and receives data and control commands to and from the host computer 1100 and storage apparatus 1 000 for system management.

The memory 1250 stores a configuration program 1254, CDP management information 1253, CDP management program 1252, volume migration management program 1251, and journal consolidation information management program 1255. The CPU 1230 performs various functions by running various programs stored in the memory 1250.

The configuration program 1254 is a program for having the CPU 1230 set CDP management information 1253 or a value in the management table 1029. Incidentally, when setting a value in the management table 1029, to make a setting request, the CPU 1230 communicates with the CPU 1023 operating according to the storage micro program 1029. The CDP management information 1253 will be described later.

The volume migration management program 1251 is a program for having the CPU 1230 manage migration of data volumes. When migrating a data volume, the CPU 1230 collects, according to the volume migration management program 1251, the information for the latest journal for the migration source data volume (hereinafter called ‘consolidation source journal’) from the migration source storage apparatus, as well as the information for the latest journal for the migration destination data volume (hereinafter called ‘consolidation destination journal’) from the migration destination storage apparatus, and creates information ensuring continuity of the journals between the storage apparatuses (hereinafter called ‘journal consolidation information’). For example, the CPU 1230 migrates the data volume 1011 in the storage apparatus 1000 to a destination via the data network 1300.

The journal consolidation information management program 1255 is a program for having the CPU 1230 manage the journal consolidation information. According to the journal consolidation information management program 1255, the CPU 1230 collects, on a regular basis, information for journals stored in the respective storage apparatuses and, for each piece of journal consolidation information, when the relevant consolidation source journal or consolidation destination journal is deleted from the storage apparatuses, the CPU 1230 deletes the journal consolidation information from the CDP management information 1253.

The CDP management program 1252 is a program for having the CPU 1230 control the recovery using journals. According to this CDP management program 1252, the CPU 1230 identifies the logical volume storing the snapshot and journal that are necessary for the recovery using the journal consolidation information, and if necessary, makes a request to the recovery-executing storage apparatus to connect an external journal volume or external snapshot volume thereto. After that, the CPU 1230 transmits the journal and snapshot information necessary for the recovery to the recovery-executing storage apparatus and requests recovery. Incidentally, the foregoing four programs provide a CLI or the like as an interface so that the administrator or other programs can execute these programs. The timer 1260 is a normal timer having the role of providing the current time. The CPU, 1230 operating according to the volume migration management program 1251, refers to this timer 1260 when creating journal consolidation information.

FIGS. 2 to 9 show a group of tables that constitute the management table 1029. FIG. 2 shows an example of a logical volume management table 2000, part of the management table 1029. This table stores management information for logical volumes. A logical volume ID 2001 section stores the identifier for a management target logical volume. The identifier is, for example, the device number of the volume. A corresponding volume ID 2002 section stores the identifier for a physical volume or virtual volume the management target logical volume is mapped onto.

In order to set the values for the foregoing two identifiers, the configuration program 1254 provides a CLI. For example, by using the CLI, the administrator can issue a command, e.g., ‘createVOL-stid RAID600_{—}503-pe_volid P_VOL_{—}01.’ This is an order for the storage apparatus RAID600_503 to ‘create a logical volume from physical volume P_VOL_{—}01.’ P_VOL_01 is stored in the corresponding volume ID 2002 section. In the logical volume ID 2001 section, the CPU 1230 assigns an identifier that can be uniquely identified in the storage apparatuses, according to the storage micro program 1028. When creating a logical volume from a virtual volume, a command may be issued by replacing P_VOL_01 with the identifier for the virtual volume.

Incidentally, in order to perform the foregoing setting, the CPU 1230, operating according to the configuration program 1254, communicates with the CPU 1023, which operates according to the storage micro program 1028. This communication is established by the CPU 1230 obtaining the IP address of the management I/F 1021 of the storage apparatus identified by RAID600_503 from the storage table 12000, which will be described later, and sending a connection request to that IP address. In the following description, when the CPU 1023 communicates with the CPU 1023, which operates according to the storage micro program 1028, to run various programs, it establishes the communication as above, so that explanation will be omitted.

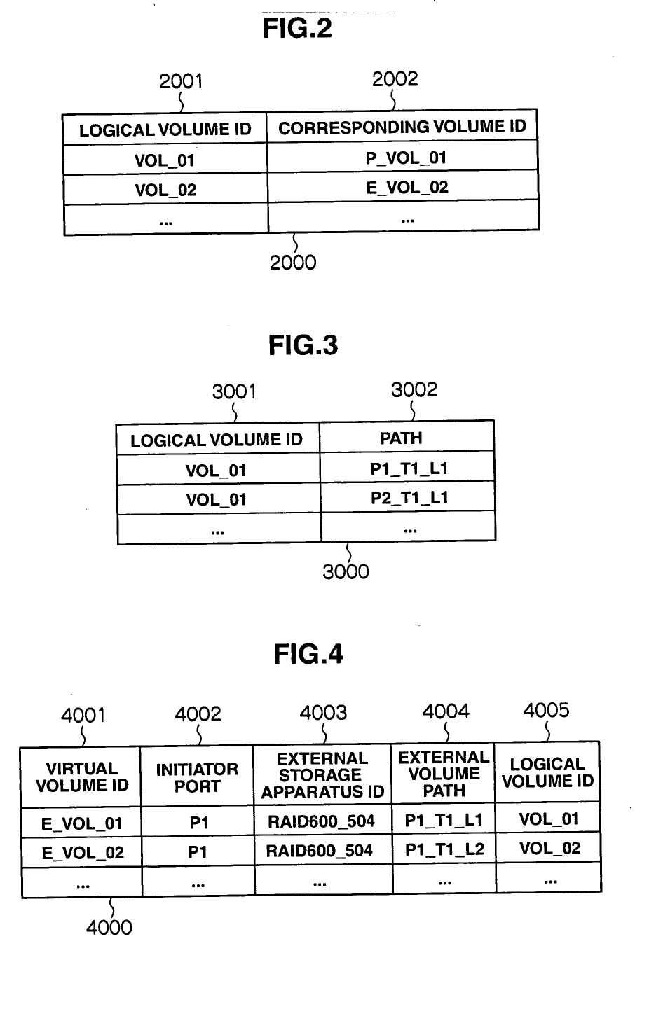

FIG. 3 shows an example of a path management table 3000, part of the management table 1029. This table manages information for paths to access logical volumes. A logical volume ID 3001 section stores the value of a logical volume ID 2001, the value being the identifier for the logical volume. A path 3002 section stores information for a path to access a logical volume. In order to set these values, the configuration program 1254 provides a CLI. For example, the administrator is able to issue a command, e.g., ‘addPath -stid RAID600_{—}503-volid VOL_{—}01 -path P1_T1_L_{—}1.’ This is an order for storage apparatus RAID 600_503 to ‘set a path having port ID 1, target ID 1 and LUN 1, to the logical volume VOL_{—}01.’ VOL_01 is stored in the logical volume ID3001 section and P1_T1_L1 is stored in the path 3002 section. ‘P1_T1_L1_’ is path information defining a logical access route from the host computer to the logical volume. P1 is information (a port number) for identifying the port. The port number is information indicating via which port from among a plurality of ports in the storage apparatus the host computer can access the LU corresponding to the logical volume. A port number for a file channel switch may also be set in the management table. T1 is a target ID and L1 is a LUN, which is the identifier for the logical volume. A target is a storage apparatus and so T1 identifies the relevant storage apparatus. A plurality of LUs is connected to the storage apparatus and L1 is an identifier for one of the LUs. The host computer and the storage apparatus make I/O access to the logical volume uniquely identified by the path information.

FIG. 4 is an example of a virtual volume management table 4000, part of the management table 1029. This table stores management information for the external connection function. A virtual volume ID 4001 section stores the identifier for a management target virtual volume. An initiator port 4002 section stores the identifier for a port of the data I/F 1022 in the self storage apparatus, via which access to a logical volume (hereinafter called ‘external volume’) in another storage apparatus is made. An external storage apparatus ID 4003 section stores the identifier for the storage apparatus storing the external volume. The identifier is, for example, a combination of the model name and serial number of the storage apparatus and the value of the storage ID 12001 in the storage table 12000, which will be described later, and is stored in the section 4003. An external volume path 4004 section stores the value of a path 3002, which becomes information for the path to access the external volume. A logical volume ID 4005 section stores the value of a logical volume ID 2001, the value being the identifier for the external volume in the external storage apparatus. In order to set this information, the configuration program 1254 provides a CLI.

For example, the administrator is able to issue a command, e.g., ‘addVVOL -stid RAID600_{—}503 -estid RAID600_{—}504 -path P1_T1_L1-vol_id VOL_{—}01.’ This is an order for storage apparatus RAID 600_503 to externally connect logical volume VOL_01 in storage apparatus RAID 600_504 via the path having port ID 1, target ID 1 and LUN 1. RAID600_504 is stored in the external storage apparatus ID 4003 section, P1_T1_L1 is stored in the external volume path 4004 section, and VOL_01 is stored in the logical volume ID 4005 section. Moreover, in the virtual volume ID 4001 section, the CPU 1023 stores the identifier uniquely identifying a virtual volume, according to the storage micro program 1028.

In the initiator port 4002 section, an identifier for a port accessible to the external volume via the path is set after being automatically searched for by the CPU 1023. An external storage apparatus externally connected to the storage apparatus can access volumes therein that are mapped onto the virtual volumes in its own apparatus, via its own virtual volumes. In other words, the external storage apparatus is able to access a snapshot volume, data volume and journal volume in the connection target storage apparatus and, based on the journal consolidation information and snapshot(s) of the external storage apparatus, it can recover its data volume at an arbitrary point in time, i.e., the data volume in the state before the data volume was migrated from the connection target storage apparatus to the external storage apparatus.

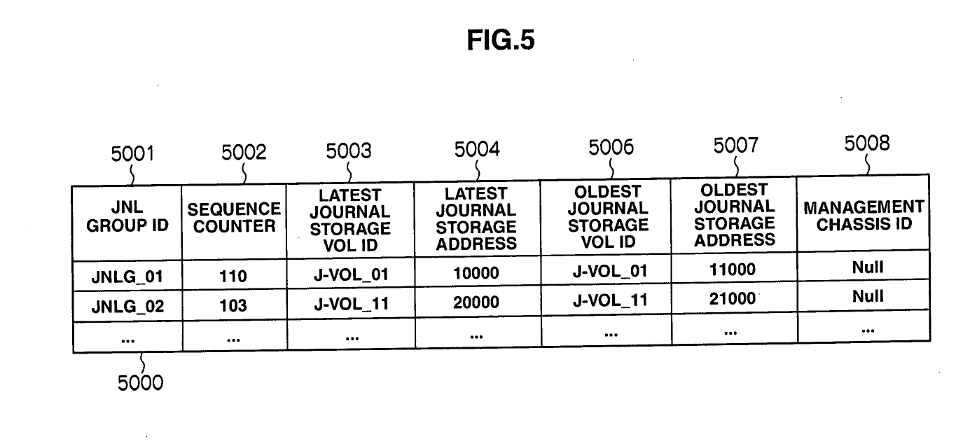

FIG. 5 shows an example of a journal group table 5000, part of the management table 1029. This table stores management information for journal groups. A JNL group ID 5001 section stores the identifier for a management target journal group. In order to set the value of the identifier, the configuration program 1254 provides a CLI. For example, the administrator is able to issue a command, e.g., ‘CreateJG -stid RAID600_{—}503 -jgid JNLG_{—}01.’ This is an order for storage apparatus RAID 600_503 to ‘create journal group JNLG_{—}01.’ The value JNLG_01 is stored in the JNL group ID 5001 section.

The sequence counter 5002 section stores a number with which the sequence of journal creation and snapshot acquisition is managed. Each time a journal is created in relation to a write request from the host computer 1100, one is added to the value by the CPU 1023, operating according to the storage micro program 1028, and the value obtained from the addition is copied to a journal sequence number 10005 section, which will be described later. Moreover, each time a snapshot is obtained, the number is copied by the CPU 1023 to a sequence number 8003 section in a snapshot group table 8000, which will also be described later.

As a result of the foregoing processing, the respective sequence relationships between journal creation timing and snapshot acquisition timing are recorded. When performing recovery, the CPU 1023, operating according to the storage micro program 1028, identifies the journals to be applied to a base snapshot and the relevant application sequence using the sequence relationships. More specifically, when performing recovery by applying After-journals to a specified snapshot, the CPU 1023 applies, to the base snapshot, journals having sequence numbers larger than that of the specified snapshot and smaller than that of the journal having the designated recovery point, according to the sequence numbers. On the other hand, when applying Before-journals to the specified snapshot, the CPU 1023 applies the journals having sequence numbers smaller than that of the snapshot and larger than that of the journal having the designated recovery point, in descending order of the sequence numbers.

A latest journal storage VOL ID 5004 section stores the value of a logical volume ID 2001, the value being the identifier for a journal volume 1013 storing the latest journal. A latest journal storage address 5005 section stores the address storing the latest journal within the journal volume.

An oldest journal storage VOL ID 5006 section stores the value of a logical volume ID 2001, the value being the identifier for a journal volume 1013 storing the oldest journal. An oldest journal storage address 5007 section stores the address storing the oldest journal within the journal volume.

The CPU 1023, operating according to the storage micro program 1028, refers to and updates the latest journal storage VOL ID 5004, latest journal storage address 5005, oldest JNL storage VOL ID 5006, and oldest JNL storage address 5007 in order to specify a storage destination volume and address for a new journal, and also to identify a journal to be deleted.

A management chassis ID 5008 section stores the value of a storage ID 12001, the value being the identifier for the storage apparatus a management target journal group belongs to. During normal operation, the value is set ‘Null.’ When the CPU 1230 obtains information for the table 5000 for performing recovery, according to the CDP management program 1252, it sets the identifier for an acquisition source storage apparatus as the value.

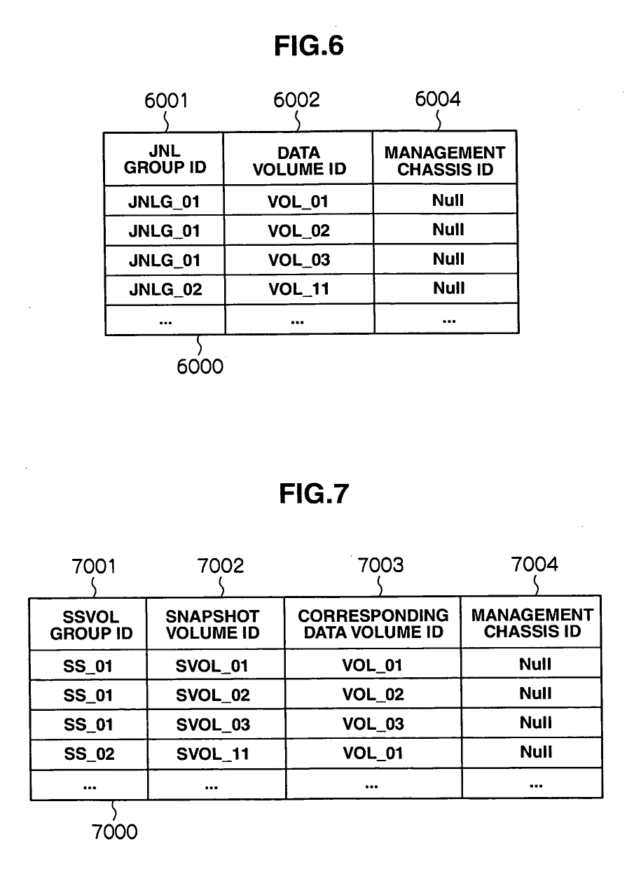

FIG. 6 shows an example of a data volume table 6000, part of the management table 1029. This table manages configuration information for journal groups. A JNL group ID 6001 section stores the value of a JNL group ID 5001, the value being the identifier for a management target journal group. A data volume ID 6002 section stores the value of a logical volume ID 2001, the value being the identifier for a data volume belonging to the journal group.

In order to set these values, the configuration program 1254 provides a CLI. For example, the administrator is able to issue a command, e.g., ‘addDataVOL -stid RAID600_{—}503 -jgid JNLG_{—}1 -datavolid VOL_{—}01.’ This commands storage apparatus RAID 600_503 to ‘add data volume VOL_{—}01 to journal group JNLG_{—}1.’ JNLG_1 is stored in the JNL group ID 6001 section and VOL_01 is stored in the data volume ID 6002 section. Incidentally, when setting a plurality of data volumes in a single journal group, the above command is executed a number of times. A management chassis ID 6004 section is the same as the management chassis ID 5008 section.

FIG. 7 shows an example of a snapshot volume table 7000, part of the management table 1029. This table manages the configuration of SSVOL groups. An SSVOL group ID 7001 section stores the identifier for a management target SSVOL group. A snapshot volume ID 7002 section stores the value of a logical volume ID 2001, the value being the identifier for a snapshot volume. 1012 belonging to the management target SSVOL group. A corresponding data volume ID 7003 section stores the value of a data volume ID 6002, the value being the identifier for the data volume that is the snapshot acquisition target.

In order to set these values, the configuration program 1254 provides a CLI. For example, the administrator is able to issue a command, e.g., ‘addSSVOL -stid RAID600_{—}503 -ssvolgid SS_{—}01 -volid SVOL_{—}01 -target VOL_{—}01.’ This is an order for storage apparatus RAID 600_503 to ‘add snapshot volume SVOL_{—}01 to SSVOL group SS_{—}01 in order to store a snapshot of data volume VOL_{—}01.’ SS_01 is stored in the SSVOL group ID 7001 section, SVOL_01 is stored in the snapshot volume ID 7002 section, and VOL_01 is stored in the corresponding data volume ID 7003 section. A management chassis ID 7004 section is the same as the management chassis ID 5008 section.

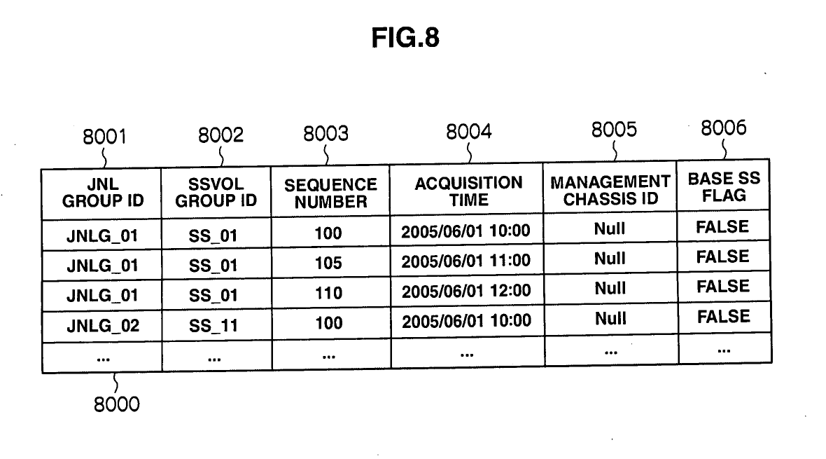

FIG. 8 shows an example of a snapshot group table 8000, part of the management table 1029. This table manages the relationships between journal groups and SSVOL groups storing snapshot groups for the journal groups. A JNL group ID 8001 section stores the value of a JNL group ID 5001, the value being the identifier for a management target journal group. An SSVOL group ID 8002 section stores the value of an SSVOL group ID 7001, the value being the identifier for a management target SSVOL group. In order to set these values, the configuration program 1254 provides a CLI. For example, the administrator is able to issue a command, e.g., ‘addSSVOLG -stid RAID600_{—}503 -jgid JNLG_{—}01 -ssvolgid SS_{—}01.’ This is an order for storage apparatus RAID 600_503 to ‘store a snapshot group for journal group JNLG_{—}01 in SSVOL group SS_{—}01.’ JNLG_01 is stored in the JNL group ID 8001 section and the value SS_01 is stored in the SSVOL group ID 8002 section. Incidentally, when associating a plurality of SSVOL groups to a JNL group in order to maintain multiple generations of snapshots, the above command is executed a number of times.

A sequence number 8003 section stores a number indicating the sequence relationship between the acquisition timing of a snapshot group stored in the management target SSVOL group and journal creation timing. Each time a snapshot is obtained, the CPU 1023, operating according to the storage micro program 1028, sets the value of the sequence counter 5003 as the sequence number 8003.

An acquisition time 8004 section stores the time when a snapshot acquisition request reaches the storage apparatus 1000. The CPU 1023, operating according to the storage micro program 1028, obtains the current time from the timer 1024 in the disk controller 1020, and sets the time as the acquisition time 8004. Incidentally, in another embodiment, the acquisition time 8004 may be a write issue time included in a snapshot acquisition request. For example, in a mainframe environment, a plurality of mainframe hosts shares a timer providing a write request issue time, therefore, this timer can be used instead. A management chassis ID 8005 section is the same as the management chassis ID 5008 section.

The base SS flag 8006 section stores information indicating whether a snapshot becomes a base snapshot upon recovery. Specifically, if a snapshot becomes a base snapshot, ‘TRUE’ is set-otherwise, ‘FALSE’ is set in the section. During normal operation, ‘FALSE’ is set as the value. When the CPU 1230 specifies the base snapshot for recovery, according to the CDP management program 1252, it sets ‘TRUE’ as the value for the SSVOL group the snapshot belongs to.

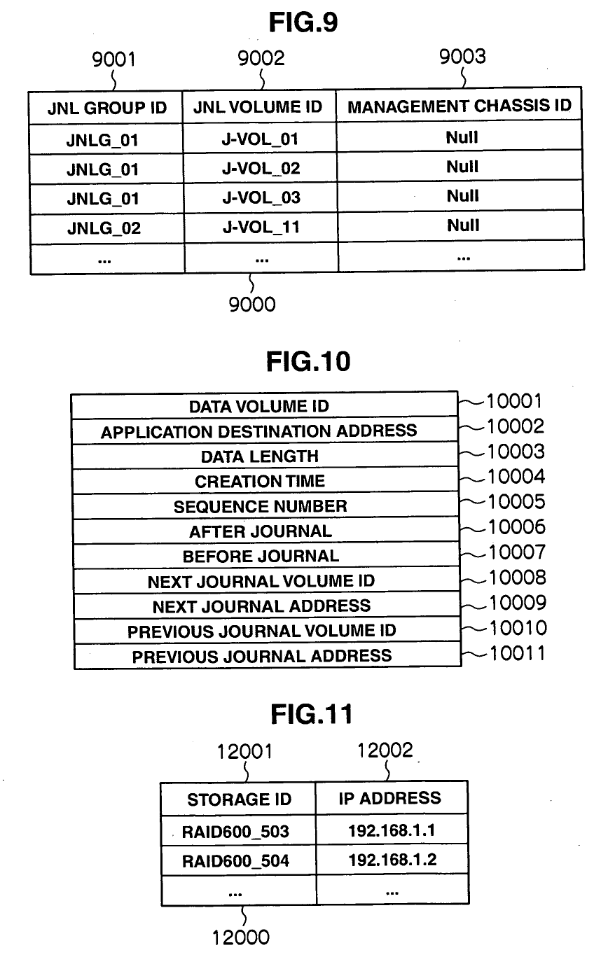

FIG. 9 shows an example of a journal volume table 9000, part of the management table 1029. This table manages journal volumes used in journal groups. A JNL group ID 9001 section stores the value of a JNL group ID 5001, the value being the identifier for a journal group. A JNL volume ID 9002 section stores the value of a logical volume ID 2001, the value being the identifier for a journal volume used by the JNL group.

In order to set these values, the configuration program 1254 provides a CLI. For example, the administrator is able to issue a command, e.g., ‘addJVOL-stid RAID600_{—}503 -jgid JNLG_{—}01 -jvolid J-VOL_{—}01.’ This is an order for storage apparatus RAID600_503 to ‘have journal group JNLG_{—}01 use journal volume J-VOL_{—}01.’ JNLG_01 is stored in the JNL group ID 9001 section and J-VOL_01 is stored in the JNL volume ID 9002 section. When associating a plurality of journal volumes with a single journal group, the above command is executed a number of times. A management chassis ID 9005 section is the same as the management chassis ID 5008 section.

FIG. 10 shows an example of the configuration of a journal according to the first embodiment. A data volume ID 10001 section stores the value of a logical volume ID 2001, the value being the identifier for a data volume 1011, which becomes the journal application destination. An application destination address 10002 section stores the application destination address inside the application destination data volume 1011. A data length 10003 section stores the length of data to be applied, i.e., the lengths of the relevant After-journal and Before-journal. These values are set in accordance with a write request from the host computer 1100 when the CPU 1023, operating according to the storage micro program 1028, creates a journal.

A creation time 10004 section stores the time when a write request from the host computer 1100 reaches the storage apparatus 1000. The value of the creation time 1004 is set by being obtained from the timer 1024 in the disk controller 1020 by the CPU 1023, operating according to the storage micro program 1028. Incidentally, in another embodiment, the creation time 10004 may be a write issue time included in a write request.

A sequence number 10005 section stores the value equivalent to the aforementioned sequence number 8003. This value is set by having one added to the value of a sequence counter 5003 when the CPU 1023, operating according to the storage micro program 1028, creates a journal. An After-journal 10006 section stores After-journal data. A Before-journal 10007 section stores Before-journal data.

A next journal volume ID 10008 section and next journal address 10009 section store information for identifying the storage position of a journal (hereinafter called ‘next journal’) to be created next to the subject journal. The next journal volume ID 10008 section stores the value of a logical volume ID 2001, the value being the identifier for a journal volume 1013 storing the next journal. The next journal address 10009 section stores the address of the position within the logical volume where the next journal is stored. This value is set by the CPU 1023, operating according to the storage micro program 1028, determining a storage position for the next journal from the appropriate free space inside the journal volume.

A previous journal volume ID 10010 section and previous journal address 10011 section store information for identifying the storage position of the journal (hereinafter called ‘previous journal’) that was created just before the subject journal. The previous journal volume ID 10010 section stores the value of a logical volume ID 2001, the value being the identifier for a journal volume 1013 storing the previous journal. The previous journal address 10011 section stores the address of the position within the logical volume where the previous journal is stored. When creating a journal, the CPU 1023, operating according to the storage micro program 1028, copies the values of the latest journal storage VOL ID 5004 and latest journal storage address 5005 to the previous journal volume ID 10010 section and previous journal address 10011 section. Then, the CPU 1023 sets the storage location of the created journal as the latest journal storage VOL ID 5004 and latest journal storage address 5005.

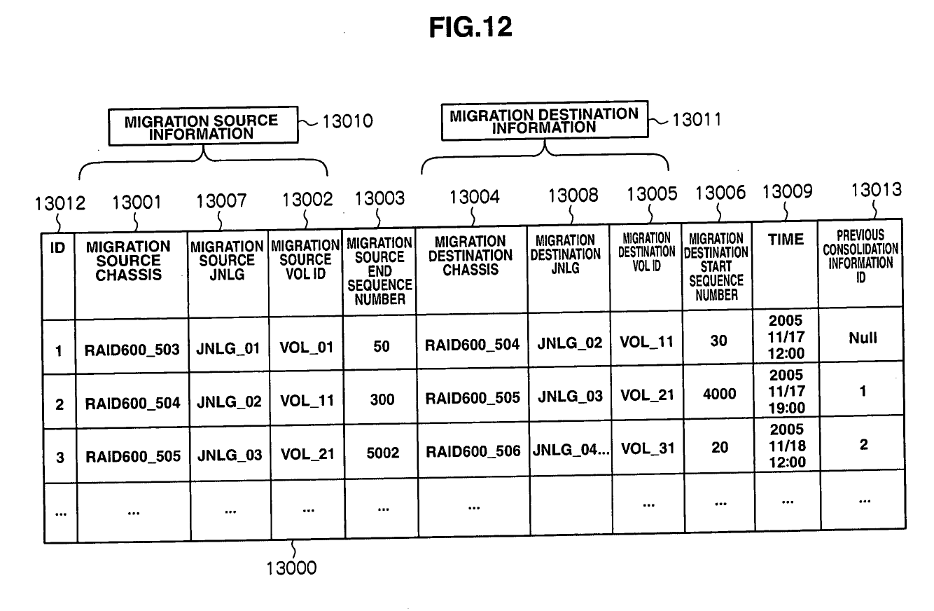

FIG. 11 and FIG. 12 show a group of tables that constitute the CDP management information 1253. FIG. 11 shows an example of a storage table 12000, part of the CDP management information 1253. This table manages information for storage apparatuses. A storage ID 120001 section stores the identifier for a storage apparatus. More specifically, the identifier includes the model name and serial number of the storage apparatus. An IP address 12002 section stores a network address, such as the IP address of the management I/F 1012 in the storage apparatus. These values are set by the administrator using the CLI provided by the configuration program 1254. For example, the administrator issues a command, e.g., ‘addstorage-stid RAID600_{—}503 -ip 192.168.1.1.’ This is an order to ‘manage storage apparatus RAID600_{—}503 having IP address 192.168.1.1.’ RAID600_503 is stored in the storage ID 12001 section and 192.168.1.1 is stored in the IP address 12002 section.

FIG. 12 shows an example of a journal consolidation information table 13000, part of the CDP management information 1253. This table manages pieces of journal consolidation information, each ensuring the continuity of journals relating to a specified data volume, the journals being distributed and stored in a plurality of storage apparatuses. The information in this table is set by the CPU 1230, operating according to a volume migration management program 1251, when migrating a data volume. An ID 13012 section stores the identifier for a piece of journal consolidation information.

A migration source chassis 13001 section stores the value of a storage ID 12001, the value being the identifier for a migration source storage apparatus. A migration source JNLG 13007 section stores the value of a JNL group ID 5001, the value being the identifier for a migration source journal group. A migration source VOL ID 13002 section stores the value of a data volume ID 6002, the value being the identifier for a migration source data volume. These three values are able to specify a unique logical volume in this embodiment. They are called migration source logical volume information 13010. A migration source end sequence number 13003 section stores the value of a sequence number 10005 of the latest journal regarding the migration source data volume, the journal being stored in the migration source journal group.

A migration destination chassis 13004 section stores the value of a storage ID 12001, the value being the identifier for a migration destination storage apparatus. A migration destination JNLG 13008 section stores the value of a JNL group ID 5001, the value being the identifier for a migration destination journal group. A migration destination VOL ID 13005 section stores the value of a data volume ID 6002, the value being the identifier for the migration destination data volume. These three values are able to specify a unique logical volume in the present embodiment. They are called migration destination information 13011. A migration destination start sequence number 13006 section stores the sequence number 10005 of the latest journal regarding the migration destination logical volume, the journal being stored in the migration destination journal group.

A time 13009 is set when creating journal consolidation information by being obtained from the timer 1260 by the CPU 1230, which operates according to the volume migration management program 1251.

A previous consolidation information ID 13013 section stores the ID 13012 of journal consolidation information previous to the journal consolidation information for the subject record. In other words, it stores the value of the ID 13012 of the journal consolidation information that ensures the continuity of the oldest journal and other journals in the journal group in which continuity is ensured by the journal consolidation information of the subject record.

### 2. Operations in the First Embodiment

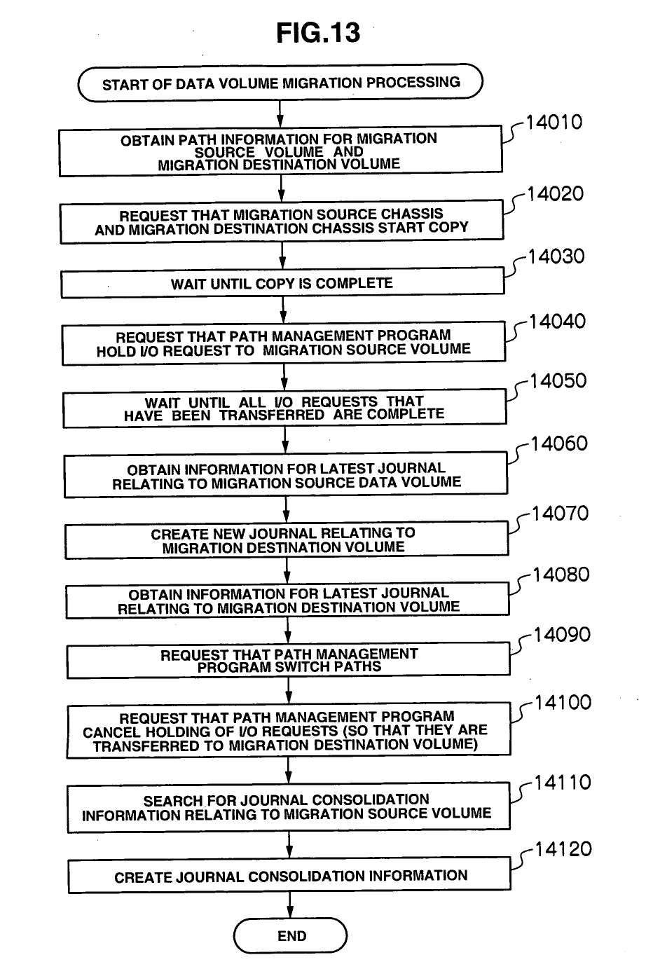

Operations in the first embodiment will be explained. First, operations for data volume migration will be explained. The volume migration management program 1251 provides a CLI for migrating a data volume. For example, the administrator is able to issue a command, e.g., ‘migrateVol-from RAID600_{—}503 -source VOL_{—}01 -to RAID600_{—}504 -target VOL_{—}02.’ This is an order to ‘migrate data volume VOL_{—}01 in storage apparatus RAID600_{—}503 to data volume VOL_{—}2 in storage apparatus RAID600_{—}504.’ FIG. 13 shows the operations performed by the volume migration management program 1251 after having received this command.

First, the CPU 1230 obtains path information for the migration source data volume from the migration source storage apparatus, and also obtains path information for the migration destination data volume from the migration destination storage apparatus (step 14010). Then, it makes a request to the migration source storage apparatus and migration destination storage apparatus to copy the data in the migration source data volume to the migration destination data volume (step 14020). Here, in order to enable the data copy between the storage apparatuses, the CPU 1230 transmits the path information for the migration destination data volume to the migration source storage apparatus. Similarly, the CPU 1230 also transmits the path information for the migration source data volume to the migration destination storage apparatus.

After that, the CPU 1230 waits until the copy is complete (step 14030). As a method for checking for copy completion, the CPU 1230 may check with the storage apparatus 1000 on a regular basis, or the CPU 1023, operating according to the storage micro program 1028, may transmit a copy completion notice to the CPU 1230.

After checking for copy completion, the CPU 1230 makes a request to the path management program 1162 to hold I/O requests to the migration source data volume (step 14040). To hold means to accumulate I/O requests from the application 1165 in a buffer and temporarily stop transmitting those requests to the migration source data volume.

The CPU 1230 then waits until all the I/O requests that have been transferred before holding the I/O requests in step 14040 have been completed (step 14050). As a method for checking for completion, the CPU 1230 ‘may check with the host computer 1100 on a regular basis, or the CPU 1130, operating according to the path management program 1162, may transmit a completion notice to the CPU 1230.

After checking for completion of all the transferred I/O requests, the CPU 1230 obtains information for the latest journal relating to the migration source data volume from the migration source storage apparatus (step 14060). Specifically, the information includes a sequence number and the identifier for the journal group the migration source data volume belongs to.

Next, the CPU 1230 makes a request to the migration destination storage apparatus to create a new journal relating to the migration destination data volume (step 14070). The journal created here is made with a data length of zero so that it will have no influence on the recovery processing.

The CPU 1230 then obtains information for the latest journal relating to the migration destination data volume from the migration destination storage apparatus (step 14080). The information includes a sequence number and the identifier for the journal group the migration destination data volume belongs to.

The CPU 1230 then makes a request to the CPU 1130, which operates according to the path management program 1162, to switch paths (step 14090), and also makes a request that it cancel holding of the I/O requests (step 14100). By switching the paths in step 14090, the I/O requests that have been held can be transferred to the migration destination logical volume.

Then, the CPU 1230 searches for the journal consolidation information relating to the migration source data volume (step 14110). This search processing is performed as follows. First, the CPU 1230 lists pieces of journal consolidation information in which the migration source information 13010 or migration destination 13011 indicates the migration source data volume concerned. Then, from among the listed pieces of journal consolidation information, the CPU 1230 determines whether the migration destination information 13011 in the latest journal consolidation information indicates the migration source data volume or not. If it does, the CPU 1230 judges that the latest journal consolidation information relates to the migration source data volume. If not, the CPU 1230 judges that there is no journal consolidation information relating to the migration source data volume.

Then, the CPU 1230 creates journal consolidation information (step 14120). Specifically, the CPU 1230 first sets the values designated by the command as the migration source chassis 13001, migration source VOL ID 13002, migration destination chassis 13004 and migration destination VOL ID 13005. It also sets the values of the journal information obtained in step 14060 and step 14080 as the migration source JNLG 13007, migration source end sequence number 13003, migration destination JNLG 13008, and migration destination start sequence number 13006. It also obtains the current time from the timer 1260 and sets it as the time 13009 and assigns an identifier to the ID 13012 for the subject journal consolidation information, and sets the value of the ID 13012 for the journal consolidation information found in step 14110 as the previous consolidation information ID 13013. Incidentally, if the journal consolidation information cannot be found in step 14110, the CPU 1230 sets ‘Null’ as the previous consolidation information ID 13013. As described above, after creating journal consolidation information, the CPU 1230 terminates the processing.

Incidentally, the flow of the present processing is premised on the migration destination data volume already belonging to a journal group; however, in another embodiment, data volume migration may be conducted after newly adding the migration destination data volume to a journal group. In that case, another step for providing a CLI for setting the data volume table may be added before step 14010. Similarly, a step for performing processing to delete the migration source data volume from the migration source journal group may be added after step 14110. This deletion processing will be described later.

Also, the flow of the present processing is premised on the migration destination data volume being recognized by the host computer; however, in a different embodiment, before switching the paths in step 14090, the host computer may be made to recognize the migration destination data volume. For example, in a UNIX (registered trademark) operating system by Hewlett-Packard, such recognition can be performed by executing an ‘IOSCAN’ command.

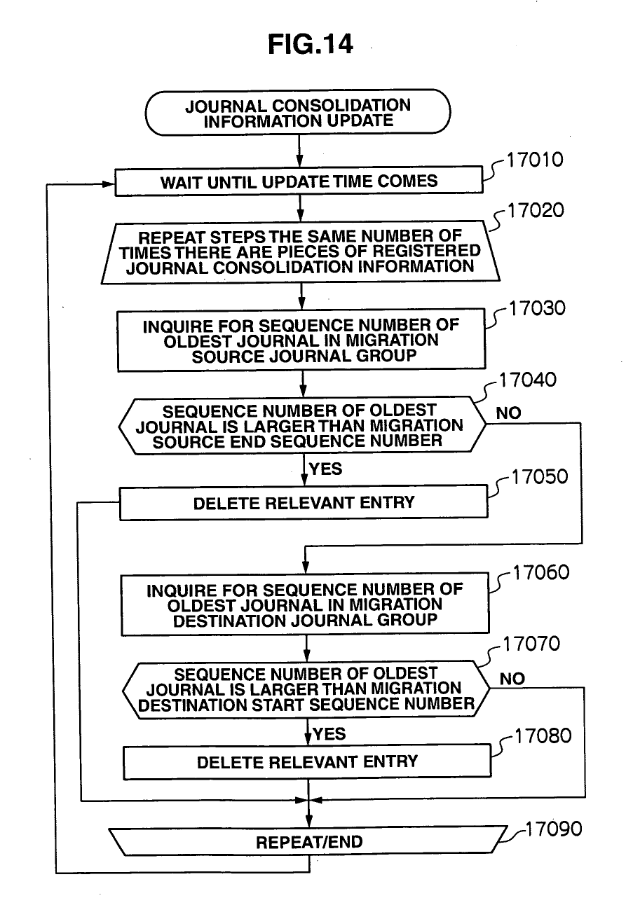

Operations for updating journal consolidation information will be explained next. The journal consolidation information management program 1255 provides a CLI for updating the journal consolidation information. For example, the administrator issues a command, e.g., ‘invokeJNLMonitor—interval 300.‘This is an order to ‘perform processing to update journal consolidation information at 300 second intervals.’ FIG. 14 shows the flow of operations performed by the CPU 1230 based on the journal consolidation information management program 1255 started in response to the above command.

First, the CPU 1230 waits until the update time comes in accordance with the designated journal consolidation information update cycle (step 17010). When it is time for the update, the CPU 1230 repeats steps 1730 to 17090 the same number of times there are pieces of journal consolidation information registered in the journal consolidation information table 13000 (step 17020).

First, the CPU 1230 obtains the sequence number of the oldest journal in the migration source journal group from the migration source storage apparatus (step 17030). The CPU 1230 compares the obtained sequence number with the migration source end sequence number 13003 (step 17040). If the obtained sequence number is larger than the migration source end sequence number 13003, it means that there is no consolidation source journal, so the CPU 1230 deletes the subject journal information (step 17050) and proceeds to step 17090. On the other hand, if the obtained sequence number is smaller than the migration source end sequence number, the CPU 1230 skips step 17050 and proceeds to step 17060.

Similarly, the CPU 1230 obtains the sequence number of the oldest journal in the migration destination journal group from the migration destination storage apparatus (step 17060) and compares the obtained sequence number with the migration destination start sequence number 13006 (step 17070). If the obtained sequence number is larger than the migration destination start sequence number, it means that there is no consolidation destination journal, so the CPU 1230 deletes the oldest subject journal information (step 17080). On the other hand, if the obtained sequence number is smaller than the migration destination start sequence number, the CPU 1230 skips step 17080 and proceeds to step 17090.

If there is a piece of journal consolidation information that has not been updated yet, the CPU 1230 returns to step 17020 and continues the processing. If update processing has been completed for all the pieces of journal consolidation information, the CPU 1230 proceeds to step 17010 and waits for the next update period (step 17090). The foregoing explains the update processing for the journal consolidation information.

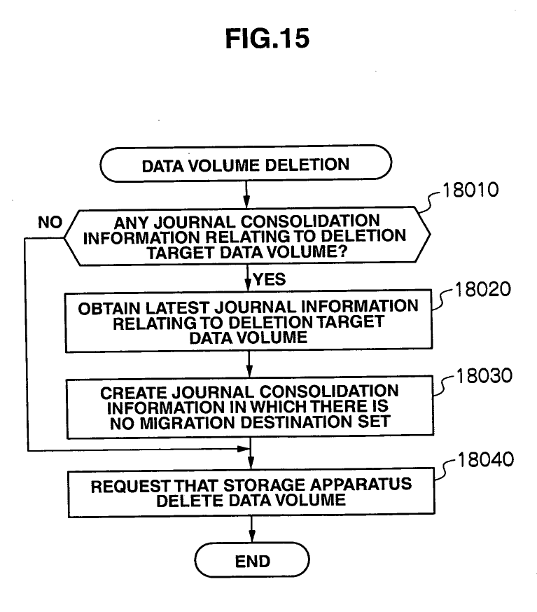

Operation for deleting a data volume from a journal group is explained next. The configuration program 1254 provides a CLI for deleting a data volume from a journal group. For example, the administrator issues a command, e.g., ‘deleteVol-stid RAID600_{—}504 -jngid JNLG_{—}04 -volid VOL_{—}31.’ This is an order for storage apparatus RAID600_504 to ‘delete logical volume VOL_{—}31 from journal group JNLG_{—}04.’ FIG. 15 shows the flow of operations performed by the CPU 1230 based on the journal consolidation information management program 1255, after having received the command.

First, the CPU 1230 searches for journal consolidation information relating to the deletion target data volume (step 18010). This search processing is performed similarly to that in step 14110. If there is a piece of journal consolidation information relating to the deletion target data volume, the CPU 1230 obtains the latest journal information relating to that deletion target volume (step 18020).

Based on that obtained journal information, the CPU 1230 creates journal consolidation information in which there is no migration destination set (step 18030). In this creation processing, the CPU 1230 sets ‘Null’ as the values for the migration destination storage apparatus 13004, migration destination JNLG 13008, migration destination VOL ID 13005, and migration destination start sequence number 13006. For values other than those values, the same values as in step 14120 are set and journal consolidation information is created.

Finally, the CPU 1230 makes a request to the storage apparatus to delete the deletion target data volume from the designated journal group (step 18040) and terminates the processing. If it is judged in step 18010 that there is no journal consolidation information relating to the deletion target data volume, step 18020 and step 18030 are skipped and the processing is terminated after step 18040.

Operations for performing recovery are explained next. The CDP management program 1252 provides a CLI for the recovery. For example, the administrator is able to issue a command such as ‘restoreVol-stid RAID600_{—}504 -volid VOL_{—}31 -rp 200511181200 -target VOL_{—}32.’ This is an order to ‘recover the data from Nov. 18, 2005 at time 12:00 in data volume VOL_{—}31 in storage apparatus RAID600_{—}504, in logical volume VOL_{—}32.’ Incidentally, the data volume to be recovered (VOL_31 in the example of the above command) is called a recovery target data volume, and the logical volume storing the recovered data (VOL_32 in the same) is called a recovery destination logical volume.

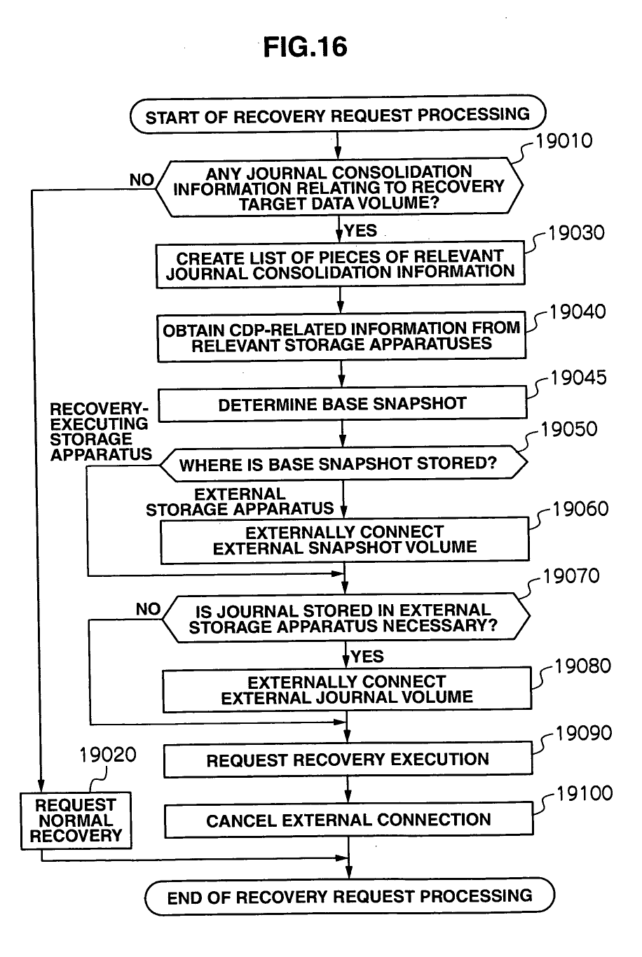

FIG. 16 shows the flow of processing performed by CPU 1230 based on the CDP management program 1252, after having received the above command. First, the CPU 1230 searches for journal consolidation information relating to the recovery target data volume (step 19010). This search is performed in the same manner as in step 14110. If there is no journal consolidation information relation to the recovery target data volume, the CPU 1230 sends a normal request to perform the recovery to the recovery-executing storage apparatus (step 19020) and terminates the processing.

Meanwhile, if there are pieces of journal consolidation information relating to the recovery target data volume, the CPU 1230 creates a list of those (step 19030). Here, the CPU 1230 creates a list using the consolidation information IDs 13013. The CPU 1230 stops creating the list when it reaches journal consolidation information having ‘Null’ or an identifier for non-existing journal consolidation information set as its consolidation information ID 13013.

The CPU 1230 then obtains CDP-related information relating to the recovery target data volume from the respective storage apparatuses listed in the list (step 19040). CDP-related information refers to the journal group table 5000, data volume table 6000, snapshot volume table 7000, snapshot group table 8000, and journal volume table 9000. Here, the CPU 1230 sets the identifiers for the information source storage apparatus as the values for the management chassis IDs 5008, management chassis IDs 6004, management chassis IDs 7004, management chassis IDs 8005, and management chassis IDs 9005.

Next, the CPU 1230 determines a base snapshot (step 19045). In this processing, the CPU 1230 first identifies the snapshot group obtained at the time closest to the designated recovery time. The CPU 1230 then identifies, from the list of the pieces of journal consolidation information, the migration source data volume for the recovery target data volume at the acquisition time for that snapshot group. The CPU 1230 then identifies, in the SSVOL group storing that snapshot group, the snapshot volume storing the snapshot of the migration source data volume. The snapshot stored in this snapshot volume becomes the base snapshot. Finally, the CPU 1230 sets ‘TRUE’ as the value of the base SS flag 8006.

The CPU 1230 then identifies the storage position of the base snapshot (step 19050). If the management chassis ID 7005 of the snapshot volume storing the specified base snapshot indicates the recovery-executing storage apparatus, step 19060 is skipped. On the other hand, if it indicates an external storage apparatus, the CPU 1230 proceeds to step 19060.

If the base snapshot is stored in an external storage apparatus, the CPU 1230 externally connects the relevant external snapshot volume thereto (step 19060). Here, the CPU 1230 first obtains path information relating to the external snapshot volume from the external storage apparatus. After that, it makes a request to the recovery-executing storage apparatus to perform external connection based on the path information, identifier for the external storage apparatus, and identifier for the external snapshot volume.

Then, the CPU 1230 determines whether the journal stored in the external storage apparatus is necessary for the recovery (step 19070). In this step, the CPU 1230 makes its judgment by using the list of the journal consolidation information and identifying the storage apparatus storing the journal created during the time between the base snapshot acquisition time and the designated recovery time.

If the journal stored in the external storage apparatus is necessary, the CPU 1230 externally connects the external journal volume thereto (step 19080). Here, the CPU 1230 identifies the storage apparatus storing the journal and the journal group the journal application destination data volume belongs to by using the list of the journal consolidation information. Then, the CPU 1230 identifies the journal volume associated with the identified journal group. After that, it obtains path information for that identified journal volume from the storage apparatus and makes a request to the recovery-executing storage apparatus to perform the external connection based on that information.

The CPU 1230 then transmits the recovery request content input via the CLI, CDP-related information, and journal consolidation information list created in step 19030 to the recovery-executing storage apparatus and makes a request to the recovery-executing storage apparatus to perform the recovery (step 19090). Operations performed by the CPU 1028 based on the storage micro program 1028 that has received this request will be described later.

When the recovery is complete, the CPU 1230 makes a request to the recovery-executing storage apparatus to cancel the external connection between the external journal volume and external snapshot volume that have been externally connected in the above processing (step 19100), and terminates the processing. The foregoing are the operations based on the CDP management program 1252 having received the recovery command.

Incidentally, in the present embodiment, a journal creation time or a snapshot creation time is obtained from the timer 1024 in a storage apparatus, therefore, the timers 1024 in the respective storage apparatuses must be accurate and consistent. If the consistency cannot be guaranteed, times included in the I/O requests and snapshot acquisition requests from the host computer 1100 may be used instead to set journal creation times and snapshot acquisition times. Moreover, in a different embodiment, designating a recovery point after staticizing the application 1165 during the operation, i.e., issuing a marker to all the relevant storage apparatuses and cancelling the staticization may also be considered. By making a marker as a recovery point, it is possible to make recovery points consistent among the storage apparatuses without depending on the timers 1024. This technique is described in Japanese Patent Laid-Open Publication No. 2005-190456.

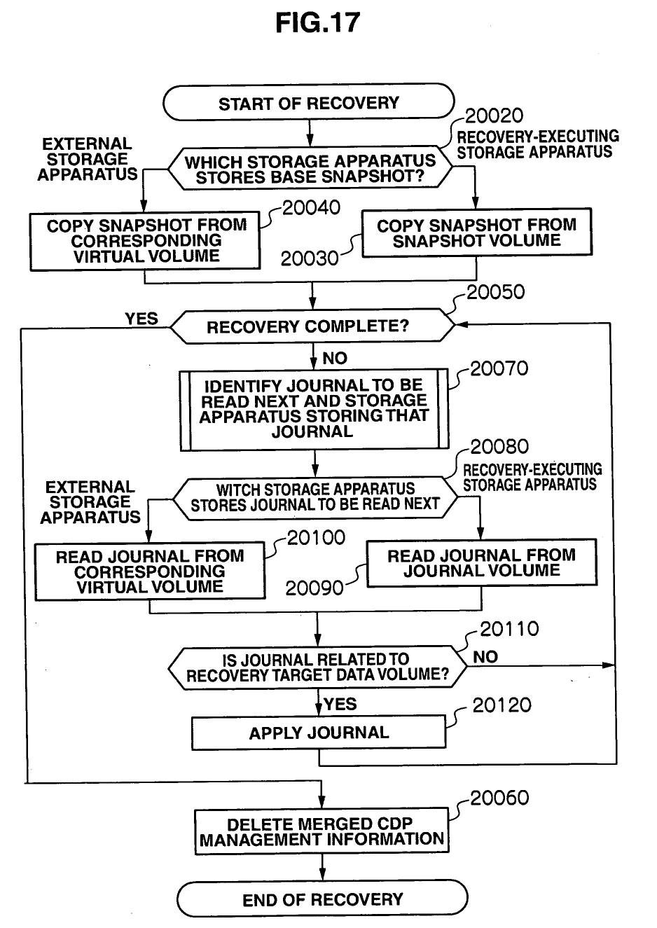

FIG. 17 shows the flow of the processing performed by the CPU 1023 based on the storage micro program 1028 having received the recovery command in step 19090. First, the CPU 1023 searches the CDP-related information received in step 19090 for the SSVOL group for which the base SS flag 8006 is set to ‘TRUE,’ and identifies the storage apparatus storing that SSVOL group (step 20020).

If the storage apparatus storing the base snapshot is the recovery-executing storage apparatus, the CPU 1023 identifies the volume storing the base snapshot in the same manner as in step 19045 and copies the base snapshot to the recovery destination logical volume (step 20030).

Meanwhile, if the storage apparatus storing the base snapshot is an external storage apparatus, the CPU 1023 copies the base snapshot from the relevant virtual volume to the recovery destination logical volume (step 20040). Here, the CPU 1023 first identifies the volume storing the base snapshot in the same manner as in step 19045. It then identifies the virtual volume from the corresponding virtual volume management table using the identifier for the snapshot-storing volume and the identifier for the external storage apparatus, and copies the base snapshot to the recovery destination logical volume.

The CPU 1023 then judges whether the recovery of the data at the designated time is complete (step 20050). If it is complete, the CPU 1023 deletes the CDP management information merged in step 20010 (step 20060), and terminates the processing.

Meanwhile, if the data of the designated time has not been recovered, the CPU 1023 identifies the journal to be read next and the storage apparatus storing that journal (step 20070). The flow of this identification processing differs depending on whether or not a journal is read in the recovery processing. This processing will be described later.

The CPU 1023 then branches the processing flow depending on the type of storage apparatus storing the journal to be read next (step 20080). If the journal to be read next is stored in an external storage apparatus, the CPU 1023 reads it from the relevant virtual volume (step 20100). More specifically, the CPU 1023 first identifies, based on the list of the journal consolidation information, the journal group the relevant data volume at the creation time of the journal to be read next belongs to.

Then, the CPU 1023 identifies the journal volume associated with the journal group. It then identifies the corresponding virtual volume from the virtual volume table 4000, using the identifier for the journal volume and identifier for the external storage apparatus. Next, the CPU 1023 searches the virtual volume for the journal to be read next and reads it. Incidentally, this step is simply described by saying ‘read the journal from the virtual volume’ on the premise of using the external connection technique disclosed in the foregoing Publication No. 2005-011277; however, the method for obtaining the journal is not limited to that. For example, the journal may be obtained in the following way. First, the CPU 1023 identifies the external storage apparatus the external journal volume belongs to, based on the virtual volume management table.

The CPU 1023 then makes an inquiry to the external storage apparatus about a journal via the management network or data network, using the identifier for the external journal volume and the storage address as keys, thus obtaining a journal.

The CPU 1023 then judges whether the migration source data volume for the recovery target data volume at the creation time of the journal matches the application target data volume for the journal (step 20110). If they match, this journal is applied (step 20120) and the CPU 1023 proceeds to step 20050. If they do not, the CPU 1023 skips step 20120.

When using a journal in the recovery-executing storage apparatus, the CPU 1023 reads it from the relevant journal volume (step 20090). Then, it proceeds to step 20110.

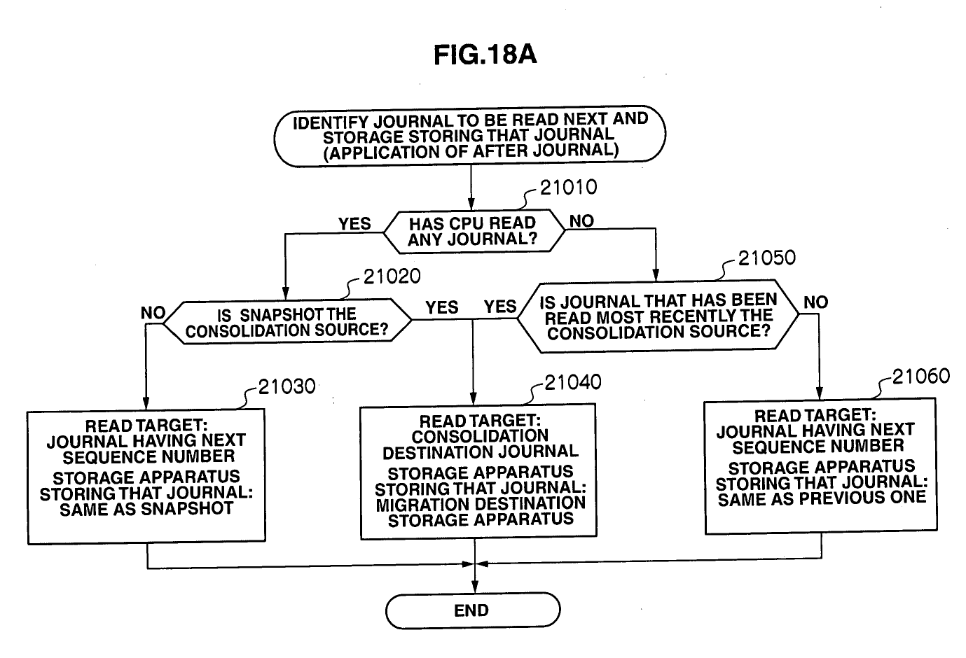

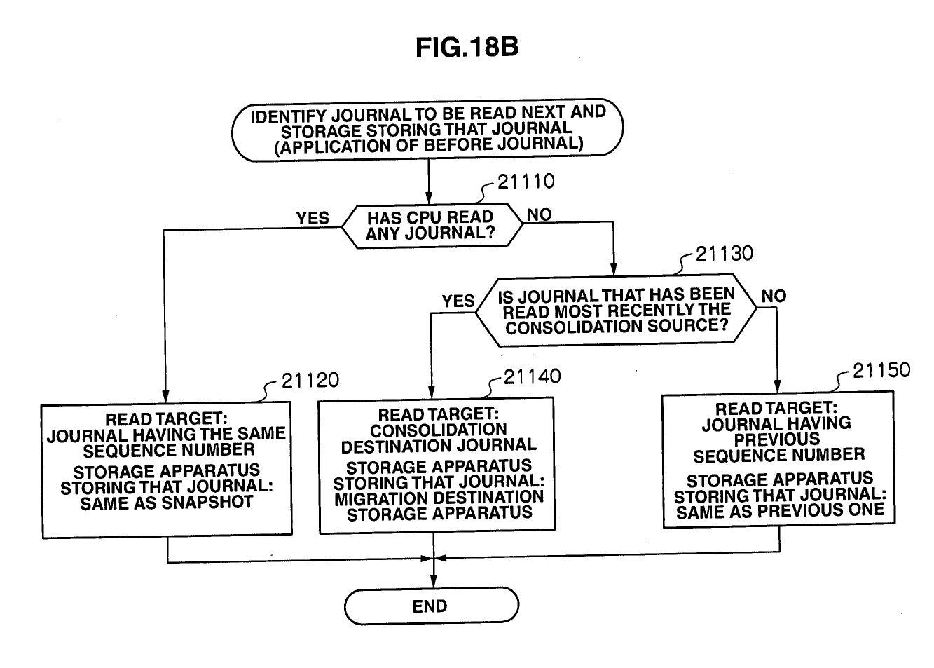

FIGS. 18A and 18B show the processing flow in step 20070 performed by the CPU 1023. FIG. 18A is explained first. This processing is special processing performed, when performing recovery using After-journals, by the CPU 1023 for the storage apparatus storing the journal to be read next.

First, the CPU 1023 judges whether it has read a journal in the current recovery processing (step 21010), and if it has not, it further judges whether the foregoing copied snapshot is the consolidation source for the journal consolidation information (step 21020). If it is not, the CPU 1023 determines that the journal having the next sequence number and stored in the same storage apparatus as the copied snapshot is the journal to be read next (step 21030). On the other hand, if the copied snapshot is the consolidation source, the CPU 1023 determines that the consolidation destination journal stored in the same migration destination storage apparatus as the journal consolidation information is the journal to be read next (step 21040).

Meanwhile, if it is judged in step 21010 that the CPU 1023 has read a journal, the CPU 1023 further judges whether the journal that has been read most recently is the consolidation source for the journal consolidation information (step 21050). If it is not, the CPU 1023 determines that the journal having the next sequence number and stored in the same storage apparatus as the most recently-read journal is the journal to be read next (step 21060). On the other hand, if the journal is the consolidation source, the CPU 1023 determines that the consolidation destination journal stored in the same migration destination storage apparatus as the journal consolidation information is the journal to be read next (step 21040).

FIG. 18B is explained next. This processing is special processing performed, when performing recovery using Before-journals, by the CPU 1023 for the journal to be read next and for the storage apparatus storing that journal.

The CPU 1023 first judges whether it has read a journal in the current recovery processing (step 21110) and if it has not, it determines that the journal having the same sequence number as the copied snapshot and stored in the same storage apparatus as the copied snapshot is the journal to be read next (step 21120).

Meanwhile, if the CPU 1023 judges that it has already read a journal in the judgment in step 21110, it further judges whether the journal that has been read most recently is the consolidation destination for the journal consolidation information (step 21130). If it is not, the CPU 1023 determines that the journal having the previous sequence number and stored in the same storage apparatus as the most recently-read journal is the journal to be read next (step 21150). On the other hand, if the journal is the consolidation destination, the CPU 1023 determines that the consolidation destination journal stored in the same migration destination storage apparatus as the journal consolidation information is the journal to be read next (step 21140). This is the flow of the recovery processing.

The foregoing is an explanation of the first embodiment. According to this embodiment, even after a data volume is migrated between storage apparatuses, data can be recovered using journals. Moreover, regarding backup and restore using journaling, snapshots and journals are deleted as time advances starting with the oldest one; accordingly, those snapshots and journals aggregate in migration destinations after a certain period of time. Therefore, it is apparently unnecessary to migrate the snapshots and journals to a destination, and accordingly, the load on the CPUs in the storage apparatuses and the load on transfer paths can be reduced.

### Second Embodiment

The second embodiment of this invention is explained next. In this embodiment, a first storage apparatus virtualizes a volume of an external storage apparatus using the external connection function and uses it in its own apparatus as a data volume (‘hereinafter called virtual data volume’) constituting a journal group. In such a configuration, the same volume in the external storage apparatus is also externally connected to a second storage apparatus, which creates a virtual data volume so that the virtual data volume can be migrated between the storage apparatuses. However, in this case, there is a problem in that journals and snapshots related to the virtual data volume are distributed among the storage apparatuses, which disables recovery using journaling. The second embodiment is used to explain that this invention can be applied to such a configuration.

### 1. System Configuration in the Second Embodiment

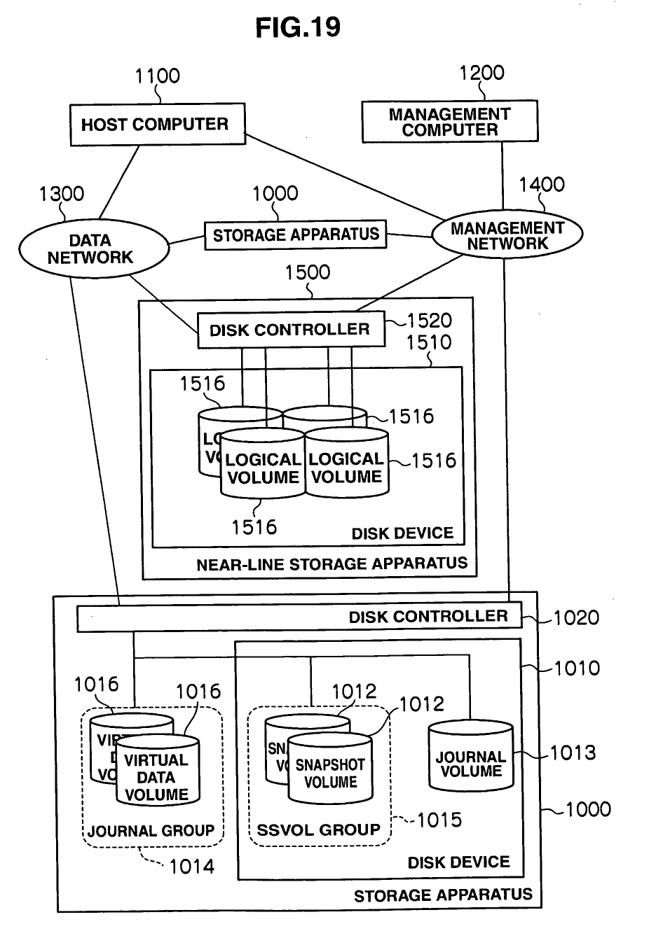

FIG. 19 is a block diagram showing the configuration of the storage apparatus according to the second embodiment. The configuration is approximately the same as that in the first embodiment, therefore, only differences will be explained below.

The system shown in FIG. 19 has a newly-added near-line storage apparatus 1500. The near-line storage apparatus 1500 is connected to the storage apparatus 1000 and host computer 1100 via the data network 1300. It is also connected to the storage apparatus 1000, host computer 1100, and management computer 1200 via the management network 1400. In the second embodiment, for ease of explanation, only one near-line storage apparatus 1500 is shown, however, there may be more than one near-line storage apparatus. The near-line storage apparatus 1500 has a disk controller 1520 and disk device 1510.

The basic functions of the disk device 1510 are the same as that of the disk device 1010. The disk device 1510 stores a logical volume 1516. The logical volume 1516 is used as an external volume by other storage apparatuses using the external connection function.

The configuration of the disk controller 1520 is the same as that of the disk controller 1020. However, for the storage micro program 1028 in the memory, various functions for backup and recovery using journaling, functions for copying data to other storage apparatuses, and external connection function are not essential.

Also, the journal group 1014 in the storage apparatus 1000 is not composed of a data volume 1011 but of a virtual data volume 1016. The virtual data volume 1016 is a virtual volume of the logical volume 1516 in the near-line storage apparatus, which is virtualized using the external connection function. Therefore, a journal group 1014 does not exist in the disk apparatus 1010 but is virtually configured in the memory in the disk controller 1020.

A request for writing in the virtual volume 1016 transmitted from the host computer 1100 is processed by the storage micro program 1028 and reflected in the logical volume 1516 corresponding to the virtual data volume 1016. Here, the storage micro program 1028 creates journals—the data to be written is made to be an After-journal and the data to be overwritten is made to be a Before-journal—and provides them with appropriate metadata by, for example, assigning sequence numbers in the order of transmission, and stores them in the journal volume 1013 associated with the journal group 1014.

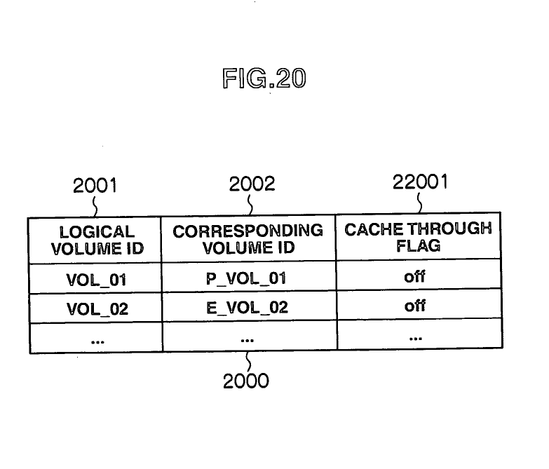

FIG. 20 shows an example of a logical volume management table. Unlike the first embodiment, this table does not necessarily require a data copy progress flag 2003 section or copy progress pointer section. However, a cache through flag 22001 section has been added. This cache through flag section stores a value indicating whether buffering is enabled for a request for writing in a management target logical volume or not. Specifically, if ‘off’ is set, buffering is enabled. If ‘on’ is set, buffering is not performed and the write request is immediately reflected in the logical volume.

### 2. Operations in the Second Embodiment

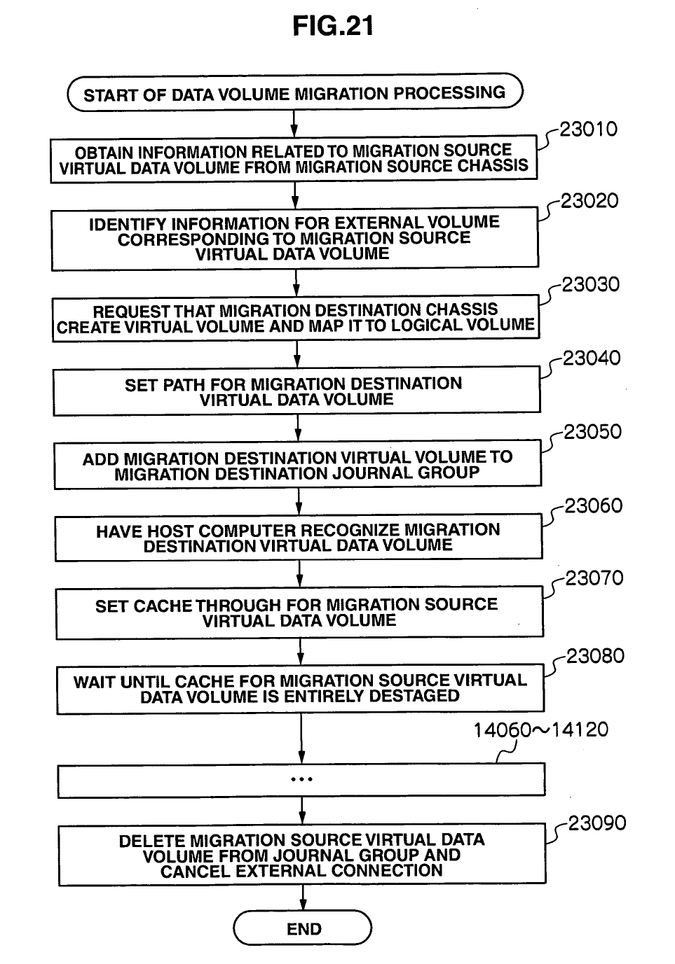

The greater part of the operations is the same as that in the first embodiment, therefore only the differences will be explained below. FIG. 21 shows the flow of processing performed by the CPU 1230 based on the volume migration management program 1251 when the administrator requests migration of a virtual data volume.

First, the CPU 1230, operating according to the volume migration management program 1251, obtains information related to the migration source virtual data volume from the migration source storage apparatus (step 23010). The information is specifically the logical volume management table and virtual volume table.

The CPU 1230 then identifies the information for the external volume corresponding to the designated migration source virtual data volume, from among the information obtained above (step 23020). Here, the CPU 1230 searches the logical volume management table 2000 for the virtual volume corresponding to the migration source virtual data volume designated by the command. After that, from the virtual volume management table 4000, the CPU 1230 identifies the external storage apparatus ID 4003, external volume path 4004, and logical volume ID 4005 for the virtual volume.

The CPU 1230 then makes a request to the migration destination storage apparatus to externally connect the external volume thereto and recognize it as its own logical volume, using the information for the identified external volume (step 23030). The CPU 1230 then sets a path for the created logical volume (step 23040). It then adds the created logical volume to the migration destination journal group (step 23050).

The CPU 1230 then has the host computer to recognize the created virtual data volume (step 23060). Here, the CPU 1230 executes ‘IOSCAN’ or the like in the UNIX operating system by Hewlett-Packard.

Then, the CPU 1230 makes a request to the migration source storage apparatus to have a request for writing in the migration source virtual data volume not pass through the cache (step 23070). Having received this request, the CPU 1023, operating according to the storage micro program 1028, sets the cache through flag in the logical volume management table 2000 to ‘on.’

After that, the CPU 1230 waits until the cache for the migration source virtual data volume has been entirely destaged (step 23080). Confirmation of destaging completion may be performed by the CPU 1230 checking with the migration source storage apparatus or by the CPU 1023, operating according to the storage micro program 1028, transmitting a notice to the volume migration management program 1251.

Steps 14060 to 14120 are the same as those in the first embodiment, therefore the explanations for them are omitted. After creating journal consolidation information in step 14120, the CPU 1230 deletes the migration source virtual data volume from the journal group in the migration source storage apparatus and cancels the external connection (step 23090). This is the flow of the virtual data volume migration processing according to the second embodiment.

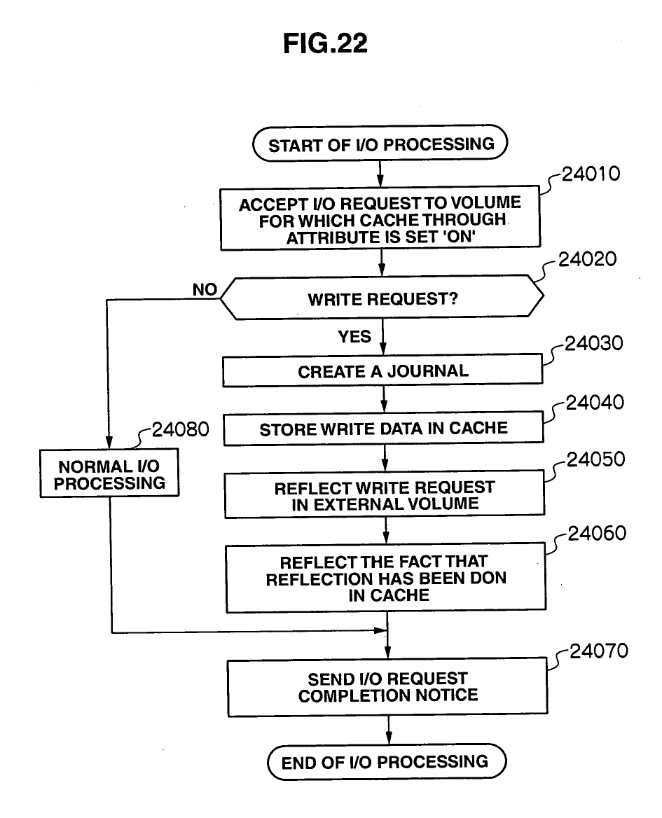

FIG. 22 shows the flow of processing performed by the CPU 1023 based on the storage micro program 1028 having received an I/O request for the virtual data volume that is being migrated. The CPU 1023 first accepts an I/O for the virtual data volume for which the cache through attribute is set to ‘on’ (step 24010). Whether or not the attribute is set to ‘on’ can be determined by referring to the cache through flag 22001 section in the logical volume management table.

The CPU 1023 then judges whether the I/O request is a write request (step 24020). If it is a read request, the CPU 1023 performs normal I/O processing (step 24080) and sends an I/O request completion notice to the host computer (step 24070).

Meanwhile, if the I/O request is a write request, the CPU 1023 first creates a journal (step 24030). Then, it stores the write data in the cache (step 24040). This cache is a cache for speeding up data reading. The CPU 1023 then reflects the write request in the external volume (step 24050). It further reflects the fact that the write request has been already reflected in the external volume in the management information for the write data stored in the cache (step 24060). Finally, the CPU 1023 sends an I/O request completion notice to the host computer (step 24070) and terminates the processing.

The foregoing is an explanation of the second embodiment. According to this embodiment, data can be recovered using journals even after a virtual data volume is migrated between storage apparatuses.

Moreover, with backup and restore using journaling, snapshots and journals are deleted as time progresses, starting with the oldest one, so the snapshots and journals aggregate in migration destinations after a certain period of time. Accordingly, it is apparently unnecessary to migrate the snapshots and journals, and accordingly the load on the CPUs in the storage apparatuses and the load on the transfer paths can be reduced.

### Third Embodiment

The third embodiment of this invention is explained next. This embodiment adopts the configuration where, in addition to a data volume constituting a journal group being a virtual volume (virtual data volume), a snapshot volume constituting an SSVOL group, and a journal volume are also virtual volumes. In the following description, a virtual volume serving as a snapshot volume is called a virtual snapshot volume, and a virtual volume serving as a journal volume is called a virtual journal volume.

### 1. System Configuration in the Third Embodiment

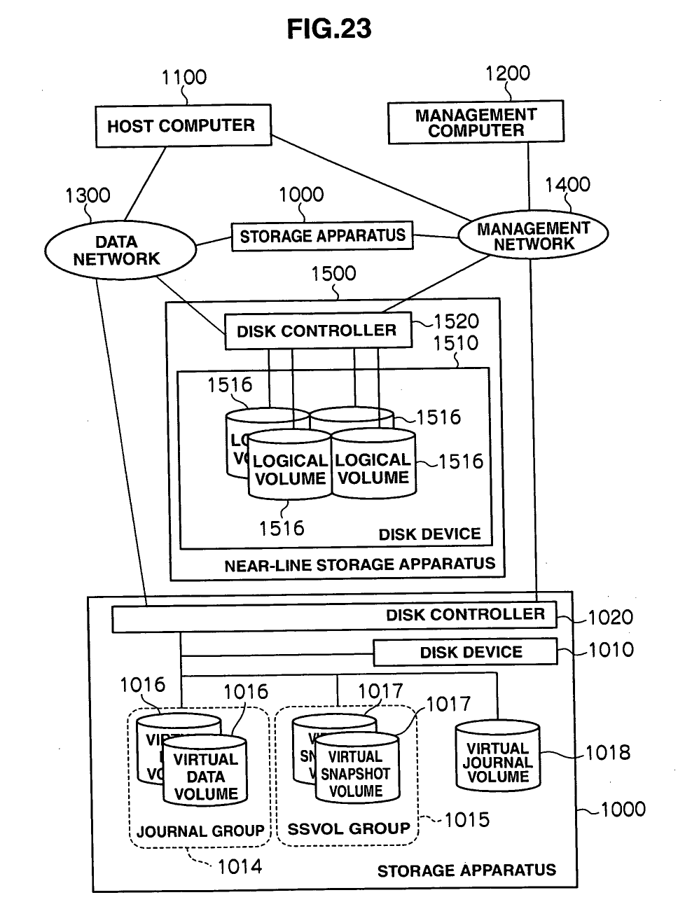

FIG. 23 is a block diagram showing the configuration of a storage apparatus. The greater part of this configuration is the same as that in the second embodiment, so only the differences will be explained below. In a storage apparatus 1000, an SSVOL group 1015 is not composed of a snapshot volume 1012 but from a virtual snapshot volume 1017. This virtual snapshot volume 1017 is a volume formed by virtualizing a logical volume 1516 in a near-line storage apparatus 1500 by means of external connection. Accordingly, the SSVOL group 1014 does not exist in the disk device 1010 but is virtually configured in the memory.

Moreover, the storage apparatus 1000 has a virtual journal volume 1018, not a journal volume 1013. This virtual journal volume 1018 is a volume formed by virtualizing the logical volume 1516 in the near-line storage apparatus 1500 by means of external connection. Therefore, the virtual journal volume 1018 does not exist in the disk device 1010 but is virtually configured in the memory in the disk controller 1020.

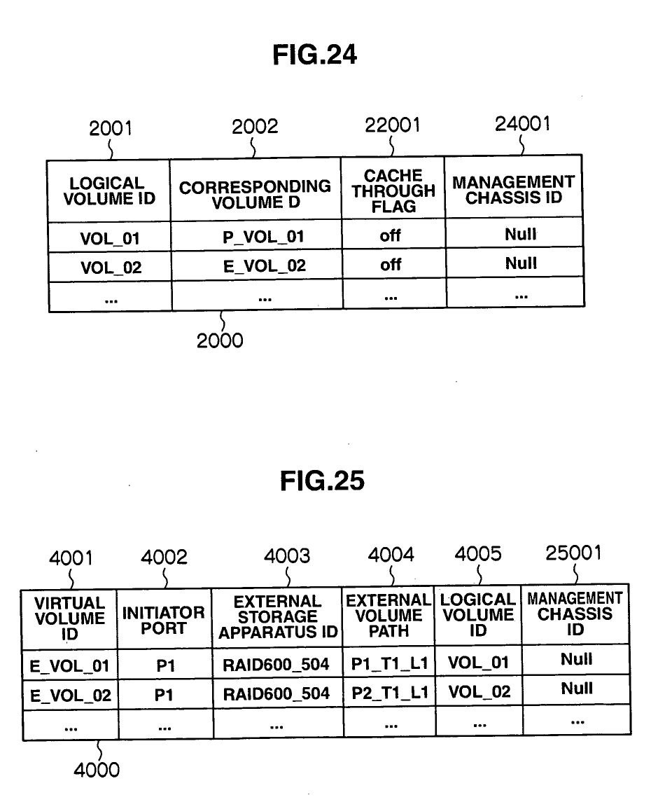

FIG. 24 shows an example of the logical volume management table according to the third embodiment. Unlike the second embodiment, this table has a newly-added management chassis ID 24001 section. A value stored in this section is the same as one stored in the management chassis ID 5008 section.

FIG. 25 shows an example of the virtual volume management table according to the third embodiment. Unlike the second embodiment, this table has a newly-added management chassis ID 25001 section. A value stored in this section is the same as one stored in the management chassis ID 5008 section.

### 2. Operations in the Third Embodiment

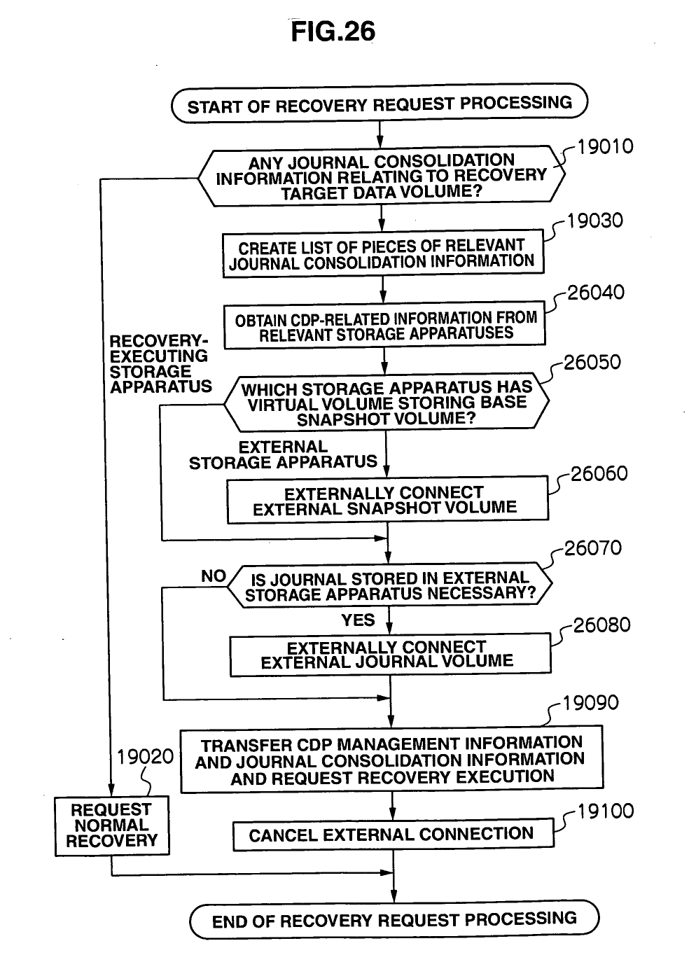

The greater part of operations in the third embodiment is the same as that in the second embodiment, so only the differences will be explained below. FIG. 26 shows the flow of processing performed by the CPU 1230, operating according to the CDP management program 1252, after having received a recovery command.

The CPU 1230 first performs the same operations as in the second embodiment from step 19010 to step 19030. Then, it obtains CDP-related information from the relevant storage apparatus (step 26040). This CDP-related information includes, in addition to the information obtained in the second embodiment, the logical volume management table and virtual volume management table. Here, the CPU 1230 sets the identifier for the information source storage apparatus as the values of the management chassis ID 24001 and management chassis ID 25001.

The CPU 1230 then judges whether the snapshot volume storing the base snapshot is a virtual volume in the recovery-executing storage apparatus or a virtual volume in an external storage apparatus (step 26050).

If the snapshot volume is a virtual volume in an external storage apparatus, the CPU 1230 makes a request to the recovery-executing storage apparatus to externally connect the external snapshot volume thereto using the information for the external volume corresponding to the virtual volume (step 26060). Then, it further judges whether the journal stored in the virtual volume defined in the external storage apparatus is necessary or not (step 26070).

If the journal stored in the virtual volume in the external storage apparatus is necessary, the CPU 1230 makes a request to the recovery-executing storage apparatus to externally connect the external journal volume thereto using the information for the external volume corresponding to that virtual volume (step 26080). After that, the same operations as those in the second embodiment are performed.

The flow of processing performed by the CPU 1023 based on the storage micro program 1028 having received the recovery command in step 19090 is explained next. This processing is approximately the same as that in the second embodiment, therefore, only the differences will be explained with reference to FIG. 17.

In step 20040, the CPU 1023 copies the base snapshot from the virtual volume storing that base snapshot. Here, the CPU 1023 identifies the virtual snapshot volume in the same manner as in step 19045, and by using the identifier for the virtual snapshot volume and the identifier for the storage apparatus storing that virtual snapshot volume, obtains the identifier for the near-line storage apparatus 1500 and the identifier for the volume storing the snapshot from the logical volume management table 2000 and virtual volume management table 4000. The CPU 1023 then identifies the corresponding virtual volume based on the values of these identifiers and performs the copy.

In that step, the copy method is simply described by saying ‘the base snapshot being copied from the virtual volume to the recovery destination logical volume’ on the premise of using the external connection technique in the Publication No. 2005-011277; however, this invention is not limited to that copy method. For example, copying may be performed as follows. First, the CPU 1023 identifies, from the virtual volume management table, the external storage apparatus the external snapshot volume storing the base snapshot belongs to. The CPU 1023 then obtains the data of the base snapshot from the external storage apparatus via the management network or data network using the identifier for the external snapshot volume as a key, and copies the data to the recovery destination logical volume.

Moreover, in step 20100, the CPU 1023 identifies the virtual journal volume based on the identifier for the external storage apparatus and the identifier for the journal volume. Specifically, using the identifier for the journal volume and the identifier for the external storage apparatus, the CPU 1023 obtains information for the corresponding external volume, i.e., the identifier for the near-line storage 1500 apparatus and the identifier for the journal volume in the near-line storage apparatus 1500, from the logical volume management table 2000 and virtual volume management table 4000. Based on the values of these identifiers, the CPU 1023 identifies the virtual volume storing the relevant journal and performs copying.

The foregoing is an explanation of the third embodiment. According to this embodiment, in the backup and recovery system using journaling, the system being configured so that journals and snapshots are stored in virtual volumes, data can be recovered using journals even after a virtual data volume is migrated between storage apparatuses.

Moreover, with backup and restore using journaling, snapshots and journals are deleted as time progresse, starting with with the oldest one, so the snapshots and journals aggregate in migration destinations after a certain period of time. Accordingly, it is apparently unnecessary to migrate the snapshots and journals to a destination, and accordingly, the load on the CPUs in the storage apparatuses and the load on the transfer paths can be reduced.

What is claimed is:

1. A computer system comprising:
a memory device having a data volume storing data used by one or more host computers and a journal volume maintaining, as a journal, information for writing in the data volume by the host computer; and
a controller controlling the memory device and, when recovering the data volume, using a data image of the data volume obtained at a recovery point as a base and applying the journal to the data image to perform the recovery,
wherein, when the controller migrates the data in a data volume from among the data volumes to another data volume and is to recover the migration destination data volume, it accesses the journal in the journal volume assigned to the migration source data volume to perform the recovery.

2. The computer system according to claim 1, wherein the data image is a snapshot of the data volume obtained at a time near the recovery point.

3. The computer system according to claim 1, further comprising a first storage apparatus and a second storage apparatus connected to the first storage apparatus, the first and second storage apparatuses each having a memory device and a controller,
wherein the migration source data volume is configured in the first storage apparatus and the migration destination data volume is configured in the second storage apparatus, and
the controller in the second storage apparatus accesses the journal volume assigned to the migration source data volume.

4. The computer system according to claim 3, wherein the second storage apparatus comprises a virtual volume and, via a path formed between the virtual volume and the journal volume assigned to the migration source data volume in the first storage apparatus, the controller in the second storage apparatus accesses the virtual volume, thereby obtaining the journal data in the journal volume in the first storage apparatus.

5. The computer system according to claim 1, wherein the controller in the second storage apparatus performs recovery based on a data image of the migration destination data volume and a journal before data migration in the first storage apparatus.

6. A computer system comprising:
a data volume storing data used by a host computer;
a journal volume maintaining, as a journal, information for writing in the data volume by the host computer;
a recovery controller using, when recovering the data volume, a data image of the data volume obtained at a recovery point as a base and applying the journal to the data image to perform the recovery;
a data migration controller controlling, when there is a plurality of storage apparatus each having a data volume, migration of data between data volumes in those storage apparatuses;
a connection controller issuing an I/O request from one storage apparatus from among the plurality of storage apparatuses to another storage apparatus; and
a management computer controlling the plurality of storage apparatuses based on management information,
wherein, when migrating data between the data volumes in the storage apparatuses, the management computer creates continuous management information where there is continuity between a journal obtained in relation to the data volume in a data migration source storage apparatus and a journal obtained in relation to the data volume in a data migration destination storage apparatus.

7. The computer system according to claim 6, wherein the data image is a snapshot.

8. The computer system according to claim 7 wherein the management computer decides on a storage apparatus for performing recovery, and if that storage apparatus does not have a snapshot and/or journal necessary for the recovery, it identifies a storage apparatus having the snapshot and/or journal based on the continuous management information, and makes a request to the connection controller in the recovery-executing storage apparatus to access that storage apparatus to obtain the snapshot and/or journal.

9. The computer system according to claim 8, wherein if the storage apparatus storing the snapshot and/or journal necessary for the recovery is not the recovery-executing storage apparatus, the management computer sets a path to access that storage apparatus for the recovery-executing storage apparatus in order to obtain the snapshot and/or journal.

10. The computer system according to claim 6, wherein the management computer collects journal information on a regular basis from the journal volume in the storage apparatus and if the journal constituting the continuous management information is deleted, it deletes that continuous management information from memory.

11. The computer system according to claim 8, wherein the management computer makes a request to the storage apparatus having the data migration destination data volume to perform recovery, and also makes a request to the same storage apparatus to access another storage apparatus having a journal corresponding to the data migration source data volume to obtain that journal; and the recovery-executing storage apparatus performs the recovery at a recovery point, one prior to the data migration, based on a snapshot of the data migration destination data volume and the journal in the other storage apparatus.

12. A management computer connected a host computer and controlling a first storage apparatus and a second storage apparatus based on management information, the host computer including:
a data volume storing data used by a host computer;
a journal volume maintaining, as a journal, information for writing in the data volume by the host computer;
a recovery controller using, when recovering the data volume, a data image of the data volume obtained at a recovery point as a base and applying the journal to the data image to perform the recovery;
a data migration controller controlling, when there is a plurality of storage apparatuses each having a data volume, migration of data between the data volumes in these storage apparatuses; and
a connection controller issuing an I/O request from one storage apparatus from among the plurality of storage apparatuses to another storage apparatus;
wherein, when migrating data between the data volumes in the plurality of storage apparatuses, the management computer creates continuous management information where there is continuity between a journal obtained in relation to the data volume in a data migration source storage apparatus and a journal obtained in relation to the data volume in a data migration destination storage apparatus.

13. The management computer according to claim 12, wherein the data image is a snapshot.

14. The management computer according to claim 13, wherein the management computer decides on a storage apparatus for performing recovery, and if that storage apparatus does not have a snapshot and/or journal necessary for the recovery, it identifies the storage apparatus having the snapshot and/or journal based on continuous management information, and makes a request to the connection controller in the recovery-executing storage apparatus to access that storage apparatus to obtain the snapshot and/or journal.

15. A method for managing data recovery, wherein a management console controls a computer system using management information, the computer system including:
a data volume storing data used by a host computer;
a journal volume maintaining, as a journal, information for writing in the data volume by the host computer;
a recovery controller using, when recovering the data volume, a data image of the data volume obtained at a recovery point as a base and applying the journal to the data image to perform the recovery;
a data migration controller controlling, when there is a plurality of storage apparatuses each having a data volume, migration of data between the data volumes in these storage apparatuses; and
a connection controller issuing an I/O request from one storage apparatus from among the plurality of storage apparatuses to another storage apparatus;
wherein, when migrating data between the data volumes in the plurality of storage apparatuses, the management console creates continuous management information where there is continuity between a journal obtained in relation to the data volume in a data migration source storage apparatus and a journal obtained in relation to the data volume in a data migration destination storage apparatus and, based on this continuous management information, it makes a request to a recovery-executing storage apparatus to perform the recovery.

16. The method according to claim 15, wherein the data image is a snapshot.

17. The method according to claim 16, wherein a storage apparatus to perform recovery is decided and if this storage apparatus does not have a snapshot and/or journal necessary for the recovery, a storage apparatus having the snapshot and/or journal is identified based on the continuous management information, and the connection controller in the recovery-executing storage apparatus is requested to access that storage apparatus to obtain the snapshot and/or journal.
